(19) United States
(12) Patent Application Publication
(10) Pub. No.: US 2003/0130994 A1
(43) Pub. Date: Jul. 10, 2003

(54) Method, system, and software for retrieving information based on front and back matter data

(75) Inventors: Sadanand Singh, La Jolla, CA (US); Richard K. Belew, Cardiff, CA (US)

Correspondence Address: FOLEY AND LARDNER, SUITE 500, 3000 K STREET NW, WASHINGTON, DC, 20007, US

(73) Assignee: ContentScan, Inc.

(21) Appl. No.: 10/254,848

(22) Filed: Sep. 26, 2002

Related U.S. Application Data
(60) Provisional application No. 60/324,527, filed on Sep. 26, 2001.

(51) Int. Cl. G06F 17/30

(52) U.S. Cl. 707/3

(57) ABSTRACT

A method, system, and software for retrieving information based on front and back matter data related to the information, includes receiving search terms for retrieval of information, comparing search terms to the front and back matter data of information for incidence and/or spatial relationships, and developing a weighted score for the information based on the comparison and/or spatial relationships. The information is retrieved based on the weighted score. The information includes books, journals, or other publications related to a specialized field of knowledge.

### CROSS-REFERENCE TO RELATED APPLICATIONS

This application claims the benefit of priority under 35 U.S.C. §119(e) of provisional application serial No. 60/324,527, entitled “Method and System For Retrieving Information Based on Bibliographic Information,” filed on Sep. 26, 2001, the disclosure which is incorporated herein in its entirety.

### FIELD OF THE INVENTION

The present invention relates generally to retrieval of data related to books or other publications based on front and back matter data of the books or other publications. More specifically, the present invention relates to searching large repositories of book or publication data based on data in the structural components (“front and back matter data”) of the books or publications.

### BACKGROUND OF THE INVENTION

Current online searching tools for books (or other similar publications) are limited in the features of the search. These tools rely on the Title, Table of Contents and a subjectively generated synopsis to identify relevant titles for a given search term. These searching tools are often of limited value because they consider only those titles with keyword incidence within the aforementioned data points. The results produced by these searches do not consider content levels within the work when returning titles and they therefore often only have superficial value. Furthermore, generalized document retrieval or searching tools used, for example, on the Internet, do not provide the capability of intelligently retrieving book data based on structural components (“front and back matter data”) of the book data.

### SUMMARY OF THE INVENTION

The present invention provides exceptional and expansive searching capabilities for books. These searching capabilities may be particularly relevant, for example, within books related to the pure and applied sciences. The technology underlying this searching capabilities is discussed herein as “ContentScan.” However, it should be understood that the features of the present invention should be understood in light of the disclosure contained herein and is not intended to be limited by any presently developed implementation or embodiments discussed herein.

In one aspect, the present invention can be associated with a pan-publisher web portal which could be driven by ContentScan—the search technology in accordance with the present invention—and dedicated to the fulfillment of informational needs for post-secondary students, academics, industry, and/or government.

In one aspect, the present invention provides a computer implemented method of retrieving information based on front and back matter data related to the information, including: receiving search terms for retrieval of information; comparing search terms to the front and back matter data of information for incidence and/or spatial relationships; developing a weighted score for the information based on the comparison and/or spatial relationships; and retrieving information based on the weighted score.

In one aspect of the present invention, the information includes books, journals, or other publications related to a specialized field of knowledge.

In another aspect, the specialized field of knowledge comprises scientific, technical, or medical fields.

In one aspect of the present invention, the front and back matter data of information includes data that is a part of one of structural components of the information comprising a title, library of congress data, a table of contents, an index, a glossary, or a references section of the information.

In one aspect, the present invention includes ranking the retrieved information based on respective weighted scores of the retrieved information; and

transmitting the ranked retrieved information for display arranged on the basis of the weighted scores of the retrieved information.

In one aspect of the present invention, the front and back matter data of information includes data that is a part of one of structural components of the information comprising a containment hierarchy, a subject index, bibliographic citations, glossary, or interior pages of the information.

In one aspect, the present invention provides for developing a specialized vocabulary related to the specialized field of knowledge.

In another aspect, the present invention provides a phrasal completion widget that offers suggestions from the specialized vocabulary based on parts of search terms entered by a user.

In one aspect of the present invention, search terms that are a part of the specialized vocabulary are given a differential weight when developing the weighted score for the information.

In another aspect, the step of developing the weighted scores includes:

determining location of the search terms within the containment hierarchy of the information; determining a length normalization function based on the number of pages and the sibling sections at the location of the search terms within the containment hierarchy; and calculating the weighted score of the search terms based on the length normalization function.

A further aspect of the present invention includes: running search terms to retrieve information based on weighted scores using a first set of weights for the different structural components; determining the relevance of the retrieved information and its correlation to the first set of weights; and adjusting the first set of weights based on the determined relevance of the retrieved information and its comparison with the first set of weights.

In one aspect, the present invention provides for retaining some of the retrieved information as state information preserved across query sessions based on an indication by a user of the retrieved information.

In a further aspect, the present invention provides a computer readable medium having program code stored thereon that causes a computing system to retrieve information based on front and back matter data related to the information by performing the following steps: receiving search terms for retrieval of information; comparing search terms to the front and back matter data of information for incidence and/or spatial relationships; developing a weighted score for the information based on the comparison and/or spatial relationships; and retrieving information based on the weighted score.

In a further aspect, the present invention provides a computer implemented method of retrieving information based front and back matter data related to the information, including: providing search terms for the retrieval of information; and receiving retrieved information based on the search terms,

wherein the search terms are compared to the front and back matter data of information for incidence and/or spatial relationships, a weighted score is developed for the information based on the incidence and/or spatial relationships, and retrieved information is retrieved based on the weighted score.

In one aspect, the present invention provides a system for retrieving information based on the front and back matter data related to the information including: a server unit configured for receiving search terms for retrieval of information, comparing search terms to the front and back matter data of information for incidence and/or spatial relationships, developing a weighted score for the information based on the comparison and/or spatial relationships, and retrieving information based on the weighted score,

wherein the information comprises books, journals, or other publications related to a specialized field of knowledge.

In another aspect of the present invention the system further includes a client unit connected to the server unit through a communication network, wherein the client unit comprises an interface for generating search terms in communication with the server unit, and receiving and displaying the information retrieved by the server unit.

In a further aspect of the present invention, the communications network is the Internet and the client unit interface is a web browser.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is diagram that illustrates the structural components of book data that are used in the search and ranking methodology provided by the present invention.

FIG. 2 is a flowchart shows the interactions of one possible architecture of the ContentScan system that uses a web client interface.

FIG. 3 contains a listing of the titles used in a validation study.

FIG. 4 lists the 10 search strings used in the validation study.

FIG. 5 shows the search results of the validation study.

FIG. 6 is a screen shot showing a standard search interface.

FIG. 7 is a table showing an exemplary list of search fields.

FIG. 8 is a screen shot showing an exemplary search results page.

FIG. 9 is a screen shot showing an exemplary title detail page.

FIG. 10 is a block diagram showing the server relationships by which data and queries may interact with a database according to the present invention.

FIG. 11 is a block diagram illustrating the contents of one exemplary search.

FIG. 12 is a diagram illustrating the results from one exemplary search.

FIG. 13 is a diagram that illustrates navigating from a retrieved text.

FIG. 14 is a diagram that illustrates how components are placed within the context of a Dome system that connecting users to materials.

FIG. 15 is a diagram that illustrates an index/TOC partitioning process.

FIG. 16 is a commented code fragment that illustrates an exemplary lexically constrained indexing process.

FIG. 17 is a screen shot illustrating an exemplary interface showing a retrieved books has been selected as a part of a subsequent query.

FIG. 18 is a screen shot showing an exemplary interface 1801 in which an element of an hierarchical ontology has been selected.

FIG. 19 is a screen shot that shows an exemplary expanded view of a query window.

FIG. 20 is a screen shot showing an interface that displays a folder hierarchy based on specific query terms entered by a user.

### DETAILED DESCRIPTION OF THE INVENTION

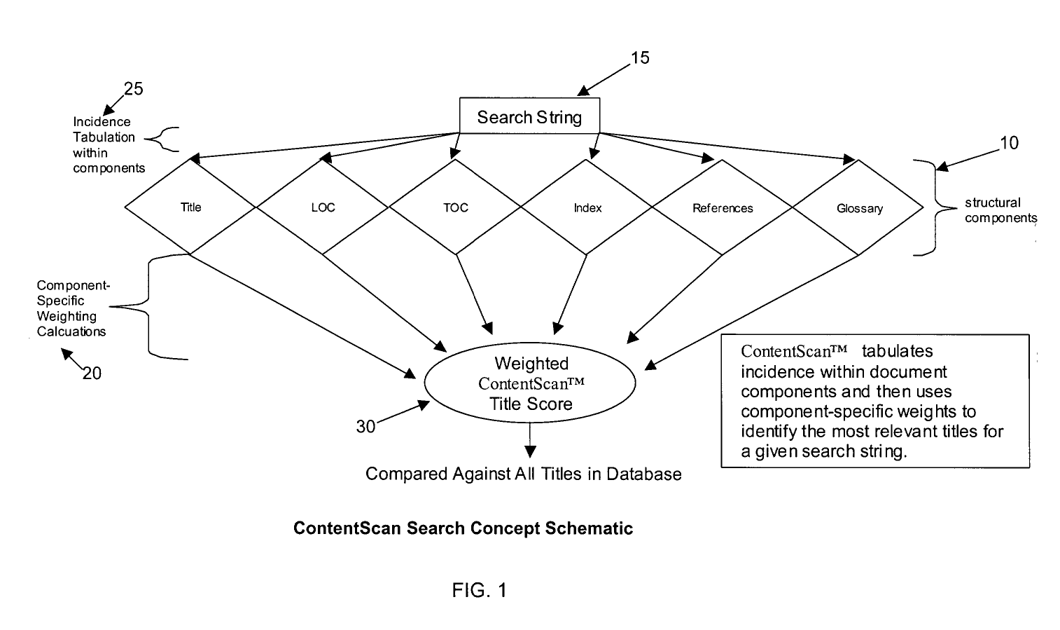

“ContentScan” is a novel information retrieval system provided by the present invention designed to search large repositories of book data. As shown in FIG. 1, ContentScan's database preferably only contain structural components of the “front- and end-matter” (title, Library of Congress info (LOC), table of contents (TOC), subject index, references, etc.) of each title. The structural components contain what is also referred to as the “front and back matter” data for the purposes of the present invention. This is because ContentScan's search algorithm determines document relevance for a given key-word search string by, inter alia, using a novel analysis of the spatial distribution of keywords within these structural components of a book.

FIG. 1 is a general representation of ContentScan's structural components 10 of book data in one embodiment that are a part of the content identification process. For a given search string 15, ContentScan utilizes incidence of keywords within the above mentioned components as an indication of content contained within the work. By establishing a relevance-determining weighting relationship 20 between document components, keyword incidence 25 within these components can be translated directly to relevance determinations and a rank ordering of relevant documents for the user by deriving a weighted score of each title 30. This unique approach provides highly detailed and accurate efficiently results with minimal amount of information for each document.

ContentScan is based on the principle that the “structure” of a book contains information about the content of the book. More importantly, the above-mentioned structural components of the book represent the content within the book to different degrees (see equation 1 further herein). This varied representation is captured by ContentScan's spatially-based weighting algorithm and allows for the identification, retrieval and relevance ranking of titles for a given search string.

Equation 1: For same levels of incidence:

### Title LOC TOC Index References Glossary

In other words, different weights are assigned to each component in order to capture its content indicating power. For example, incidence hits within the title will be weighted more heavily than hits within the table of contents as keyword matches within the title indicate the presence of content to a greater degree than do incidence hits within the table of contents. This weighting and search process will allow detailed analysis of content levels within works without requiring full-text data.

### Query-Based Searching

ContentScan performs searches based on specific query sets submitted by either human or electronic users (query submitted by another computer). All searches are carried out preferably using the submitted search string.

### Structural Organization of a Book

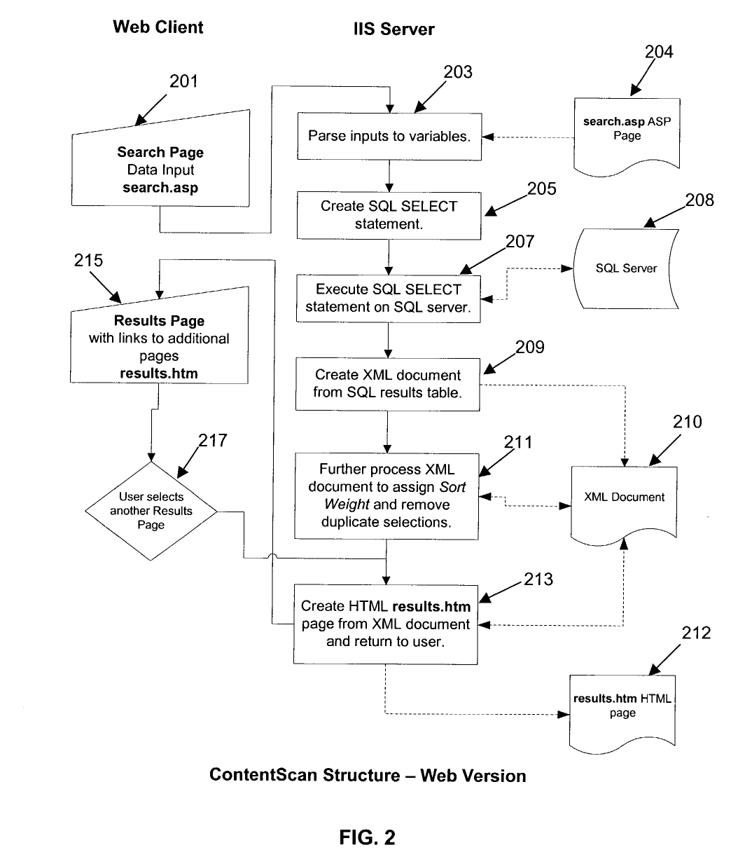

ContentScan capitalizes on the inherent structure of books or other publications or other organized information that may be retrieved. When authors of such information (books, journals, other publications or organized information) lay out the title, table of contents, etc., they do so as indications of the content held within the work. ContentScan utilizes this inherent book structure as an indication of content contained within a particular book. ContentScan's weighting algorithm attaches weights to each document component that correspond with the components inherent content-indicating ability. This hierarchical organization was explored in a manual modeling of ContentScan, the results of which can be found in Section 1 of the Detailed Description further herein. FIG. 2 is a flowchart shows the interactions of one possible architecture of the ContentScan system that uses a web client interface. The various steps in FIG. 2 are discussed further herein.

### Minimal Amount of Information—Enhanced Efficiency

Because ContentScan uses only the six components (or a limited number of components) listed above in one embodiment, it's database is populated only by information for each of the components. Because of its novel spatially-based structural analysis of these components, ContentScan searches produce similar levels of detail as full-text searches but require a fraction of the data and time currently associated with attaining full-text searching capabilities. As a result, ContentScan increases the efficiency of searching electronic repositories of book data.

### Applications

ContentScan can be used to search any repository of book data. ContentScan may therefore be applied, for example, within the following areas:

Libraries (Corporate, Governmental, Academic, etc.)

Online/Offline Booksellers (E-commerce, Brick & Mortar book sales, etc.)

Online/Offline Publisher databases (E-commerce, Product identification, Marketing etc.)

This list is not exhaustive but is exemplary only.

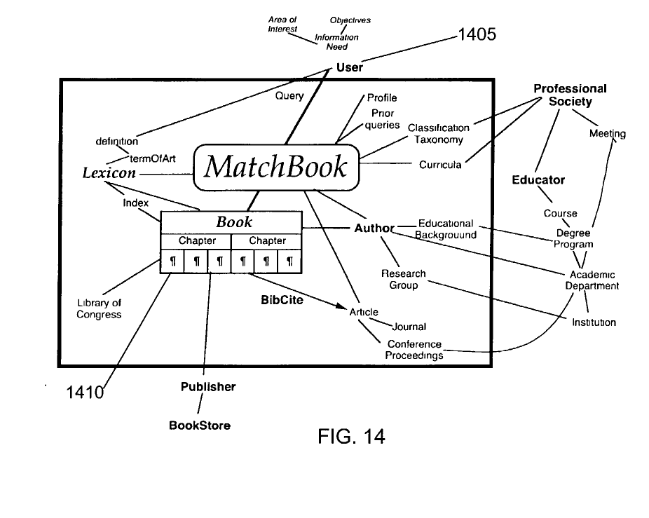

The detailed description of one embodiment of the present invention is described in the following four sections with reference to FIGS. 1-13. Another embodiment of the present invention is discussed further herein with reference to FIGS. 14-20.

Section 1—ContentScan Manual Modeling Experiment

Section 2—ContentScan/electronic portal Preliminary Technical Specification

Section 3—ContentScan/electronic portal Custom Programming Details

Section 4—ContentScan Electronic Modeling Process and Exemplary Implementations of the Present Invention

### Section 1

### A Manual Feasibility Study of ContentScan

### Abstract

ContentScan, a novel content identification system has here been subjected to a manual test in order to establish its feasibility. ContentScan's searches are based upon a variable weighting of the pre-existing architectural or structural components of a book. These components were utilized to search the content of 13 titles within the field of Dysphagia. Testing was conducted across these titles utilizing expert-generated search strings. Analysis of incidence rates within each title and architectural component on a search string specific basis revealed that: 1) search strings vary greatly with respect to incidence; 2) architectural components also varied with respect to incidence; and 3) the variation between the components was hierarchical and constant across all titles.

### Introduction

In one embodiment, ContentScan provides a novel search algorithm designed to identify targeted content within scholarly publications in the pure and applied sciences. ContentScan's search algorithm utilizes a differential weighting of the structure of professionally published books in order to identify and isolate content relevant to a given search string. This manual modeling study has been undertaken in order to validate certain implicit assumptions related to the feasibility of ContentScan. These assumptions include: 1) that the key-words appear in the structural components of texts; 2) that the incidence of key-words in the various structural components is different for different key-word search strings in the same texts; 3) that the incidence of key-words in the structural components is different for different texts using the same key-words, and therefore, texts can be differentiated from one another based on the incidence of occurrence of key-words in the end matter or structural components; and 4) that the rankings of texts are different for each search string depending on the structural components used to generate the rankings. These relationships between the document structure and incidence can be translated into relevance determinations once correlations are established between incidence rate, location, and content within titles.

The scope of this manual modeling of the ContentScan algorithm was limited to a single field of study, Dysphagia. The list of titles included in the model was limited to 13 textbooks from within the field. Ten dysphagia-specific search strings were used to evaluate the algorithm against these texts. The following six structural components were tested for each title and search string combination: Title, Library of Congress (LOC) data, Table of Contents (TOC), Index, References, and Glossary.

### Procedure

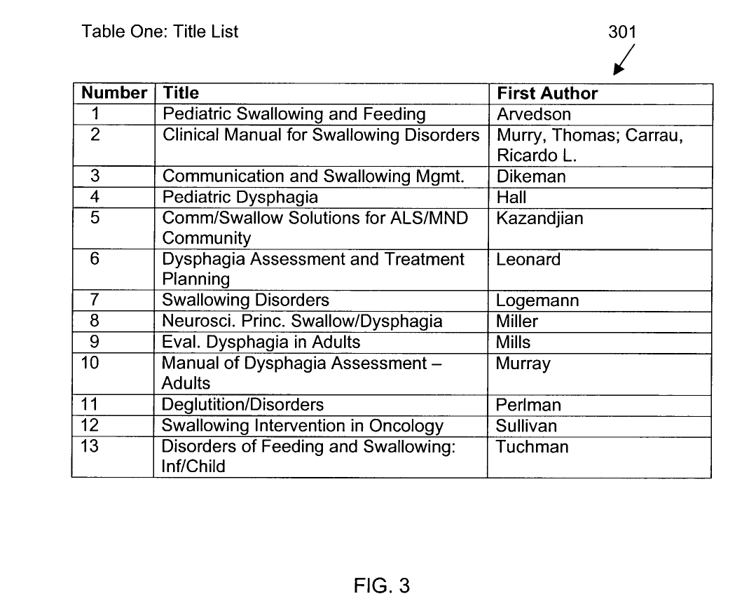

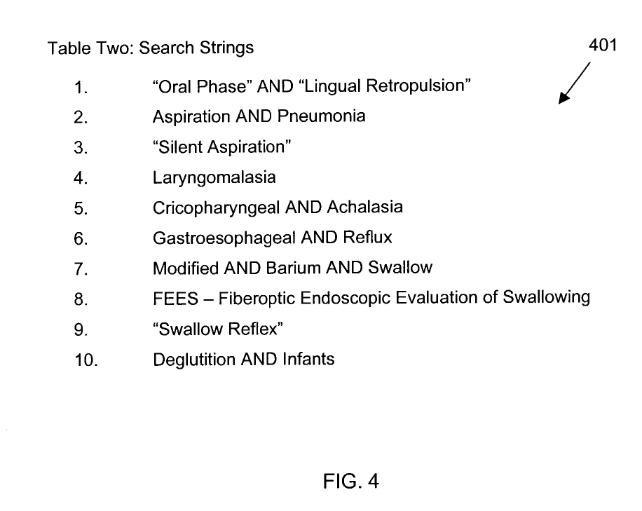

Thirteen titles were selected from within the field of dysphagia to be utilized as a broad-based content source. Table 301 in FIG. 3 contains a listing of the titles used. These 13 books, then, served as the basis for searching highly specialized content pegged to the 10 search strings listed in Table 401 in FIG. 4. Two professional practitioners selected the search words, one a professor working in a medical college environment and the other working full time as a clinician within the field. As a result, search strings addressed concepts relevant to both the academic and applied environments. Each expert was asked to select a series of terms that would represent major themes that students, teachers, practitioners, and researchers might encounter in their work settings. The 10 search words utilized in the manual model were derived from the pool of terms recommended by these two experts in the field and are listed in Table 401 in FIG. 4.

These search terms were subjected to a manual ContentScan search using each of the 13 books as the data source. The aforementioned six structural components were analyzed within each book.

### Results

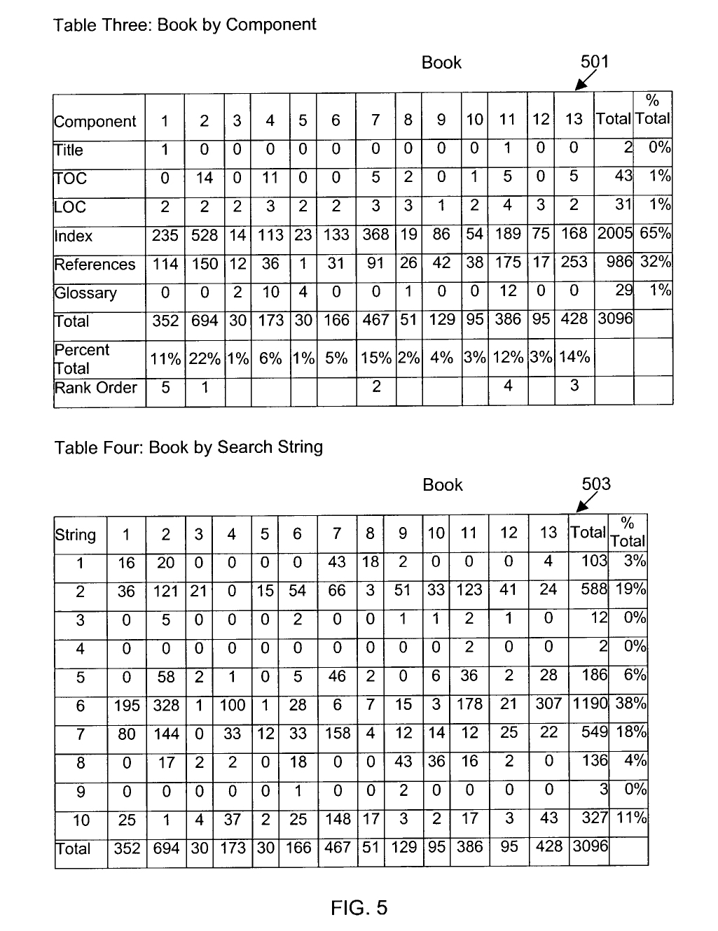

All results are shown in Tables 501 and 503 in FIG. 5. Table 501 represents the tabulation of 13 books on the horizontal axis and the six structural components on the vertical axis. The data in this table clearly indicates that the 13 highly specialized books selected have substantially differing incidence values. For example, book 2 contributed 22% of all incidences, book 7 contributed 15%, book 13 contributed 14% and book 11 contributed 12%. Thus, 4 out of 13 books accounted for a combined incidence level of 63%. On the other hand some of the other books demonstrated virtually no contribution to searches. For example, books 3 and 5 contributed 1% each, book 8, 2% and books 10 and 12, 3% each.

Table 503 shows that for each of the search strings there existed differentiation between particular books. This differentiation could be used to rank the relevance of each text for each search string. For example, for Search String 1, books 7, 2, and 8 contained the most key-word incidences and therefore could be ranked relatively higher than other books. For Search String 2, books 11, 2, and 6 were the strongest. For Search String 3, books 2, 5, and 11 accrued the most hits, and for Search String 4 only book 11 would be defined as relevant.

Table 501 also shows that of the six components employed to execute the searches, the incidence of hits within the index was 65% and within the References, 32%. Further, this hierarchy was retained throughout all books except number 13. Thus, two components accounted for 97% of all hits and their incidence hierarchy was retained through 92% of titles.

Table 503 also presents the incidences associated with each of the search terms across all 13 books. The results show that search terms also differed greatly in their ability to elicit hits across these books. Although all ten search strings were generally considered to be of equal value, in some cases, incidence rates varied by as many as one thousand hits. Four of the ten search strings received hits 86% of the time. In addition, all search strings occurred in at least 1 text and only 2 search strings occurred in less that 46% of the titles.

### Discussion and Conclusion

This study, although of limited scope, clearly demonstrated the power of the structural entities or components to differentiate between books for a given search string. As can be seen from Table 501, these components vary in their contribution to this differentiation. Also, to a certain degree this variation seems to be constant across titles. This suggests that it may be possible to assign weights to each of these components towards the creation of a replicable weighting formula applicable across titles and search strings.

It is apparent from Table 503 that search strings differed in their ability to elicit hits within titles. This suggests that a gradient or ranking of titles could be established for each search string. These findings have important bearing on the continued development of the ContentScan search algorithm. Because the evidence suggests the ability to rank titles on a search string specific basis, as well as the ability to assign universal weights to a title's structural components, the implicit assumptions described earlier upon which ContentScan rests, appear valid.

### Section 2

### ContentScan Preliminary Technical Specification

### Overview

ContentScan provides a new Internet or other computer network based service that will allow any user to use search criteria in order to locate one or more textbooks or journals containing information that the user needs for research purposes. All existing English-language textbooks may be represented in the native ContentScan database. Text may optionally be available by arrangement with the publisher.

The ContentScan Internet site allows any user to submit search criteria to the ContentScan search engine. The search engine will convert the search string to a database query, and the ContentScan database will be searched accordingly, and results will be sent back to the user.

Users will be allowed to submit a variety of criteria, including IS?N Number, search words, publisher, subject, etc. The results pages will allow the user to further narrow the search, and will give the user detailed information concerning all texts or journals that meet the search criteria.

### Nomenclature

In the preferred embodiment, ContentScan contains information for all catalogued English-language texts and journals. Texts are uniquely identified by an ISBN number, and journals are uniquely identified by an ISSN number. Whenever the term “IS?N” is used in this specification, that just refers to a title's ISBN or ISSN number, whichever is appropriate.

The term “search words” denotes individual words or phrases used in the searching of texts and journals by the user.

### Basic Structure of the Software

When a user accesses ContentScan by asking for the URL via their Internet browser, the introductory area is accessed. This web page will gives the user two choices in one embodiment:

1. Download and Install ContentScan Advanced Search software

2. Perform a ContentScan search

This introductory page lets the user know that advanced ContentScan features are only available if the software has been downloaded and installed.

The ContentScan search page accessed via this Introductory page will be streamlined version of the advanced search screen. It will not allow the user to access their own search history, and it will not allow them to be able to use their credit card for any charges.

If they opt for the download, they will be downloading and installing an icon, and a simple script program accesses the ContentScan Search Page (bypassing the Intro page) using their own web browser, when the ContentScan icon is clicked. The software also creates a datafile on the user's computer that contains the last 20 ContentScan search strings, and the user's name, credit card number and expiration date.

The storing of search history and credit card info on the user's PC is desirable for security and data storage purposes.

### Search Selection Screen

The Search Selection screen is displayed immediately when a user clicks on his/her ContentScan icon, or it is reached by selecting the Search selection from a website.

The search criteria will be as follows in one preferred embodiment:

One or more search words (advanced searches are supported using boolean operators)

Author/Editor

Subject

Title

Publisher

IS?N

The last five fields will default to “containing”. There will be an Advanced button which will allow the user to further refine the search criteria, if desired. The advanced screen will as a minimum allow the user to:

Define if the Author, Title, Publisher, Subject or IS?N search criteria is “exact match” or “containing”. Consider adding “range” (hyphen delimited) or “list” (comma delimited) criteria. Also “must contain” and “must not contain” filters may be provided. Other options include:

Limit the results page to only books or only journals.

Limit the results page to only books or journals having a:

| | | | |
|---|---|---|---|
| Synopsis | Bibliography | Photos | TOC Synopsis |

| | | |
|---|---|---|
| Text Available | Jacket | Included CD-ROM |

Order Online
Appendix

Limit the results page to only journals or texts published after a certain date.

A Search History selection on this screen is provided. It will access the last 20 searches (for example) conducted by the user. These searches will be saved on the user's computer. Each search will be saved as one long string, containing all of the user's search parameters. This selection will only be enabled if the user has downloaded the ContentScan software.

In a preferred embodiment, there will be a Registration Info selection on this screen that will allow the user to access the registration and credit card information stored in the file on the user's computer. This selection will only be enabled if the user has downloaded the ContentScan software.

The Search Selection screen will have space allocated for advertising.

### Search Engine

In one preferred embodiment, the search engine will accept the search criteria, and using the information contained within the ContentScan database, will produce the new tables shown below.

Table 1: Consists of each textbook or journal having a passage or passages meeting the search criteria. Key: IS?N No.

Table 2: Consists of all of the index keywords matching the search criteria, sorted alphabetically. There will be a fixed limit on the size of this table. If the limit is exceeded, the user will be instructed to narrow their search word search parameters. Key: Index Keyword.

Table 3: Consists of each Text/Page Number range for the records in Table 2. Key: Index Keyword/IS?N/Page Number.

Table 4: Consists of an alphabetical list of the Authors for the records in Table 1. Key: Author/IS?N.

Table 5: Consists of an alphabetical list of the Publishers for the records in Table 1. Key: Publisher/IS?N.

Table 6: Consists of an alphabetical list of the LOC Subjects for all of the records in Table 1. Key: LOC Subject/IS?N.

Table 7: Consists of a descending list of the Publish Dates for the records in Table 1. Key: Publish Date/IS?N.

Table 8: Consists of an alphabetic listing of all texts and journals contained in the bibliographies of the records in Table 1. Each record contains a pointer to the IS?N for the reference and the IS?N pointing to it. Key: Title.

### Programming Notes

1. As would be recognized by one skilled in the art, some of these tables may just be different views of the same table, but they are described below as though they were unique.

2. A unique way of naming these tables is created, possibly incorporating the user's IP address.

3. These files must be saved on the server, after the search request has been processed. The information in these files will be used to further reduce the results tables. These files will preferably be erased from the server when the user's current ContentScan session is terminated.

### ContentScan Database

In a preferred embodiment, the ContentScan database will consist of the following tables. The contents of the records will be generally described.

Table A: Consists of each catalogued English-language textbook and journal. Each entry will consist of, but not be limited to, the following information:

IS?N Number

Title

Publisher's synopsis (text)

LOC information (text)

Condensed table of contents (text)

Author

Latest edition

Date of publication

Publisher

Link to Jacket record

Date last updated

Online purchase available?

Text available?

Link to seller

Number of titles referenced in—Meaning # of relevant references w/in a text, or # of relevant references total?

Key: IS?N

Table B: Consists of keywords contained in all texts and journals having records in Table A. Each record consists of the link to the Table A record, and a page number or range of pages. A keyword is any word found in a journal or text index or a table of contents heading. Book or journal titles are also keywords. Key: Keyword/IS?N

Table C: Consists of LOC Subjects for all texts and journals having records in Table A. Key: LOC Subject/IS?N

Table D: Consists of all Journal and Textbook publishers. This table is used to drive the spider/crawler.

Table E: Consists of IS?N Numbers for each reference text or journal in Table A, contained in a text or journal's bibliography.

Table F: Consists of IS?N Numbers that reference each text or journal in Table A. This table will allow the user to view each of the texts or journals that refer to a particular text or journal in their bibliographies.

Table G: Contains biographical information, if available, for each Author having a catalogued Journal or Text.

### Spider/Crawler

In one embodiment, a spider/crawler will be responsible for the initial creation of the ContentScan database, and for regular updating of records, by scanning publishing web sites on the Internet.

Because it is impossible to differentiate between a textbook and a non-text work of non-fiction by merely inspecting the IS?N, it will be necessary to drive the textbook and journal search by searching for and loading all works having an index published by the publishers contained in Table D. It is preferable that new textbook publishers are “registered” in our database.

There may be publishers in Table D who also publish works other than journals or textbooks, so additional filters are built into the textbook/journal validation rules, that filter out other works. Those filters can use the LOC description for validation.

The publisher's web site will be searched, and each valid text or journal will be scanned. The LOC info for each will be read from an external LOC database, using the IS?N as key. Table B will be updated from the table of contents, the text or journal title, and the index.

Table C will be updated from the LOC information.

In a preferred embodiment, Table D will not be updated by the spider/crawler. It will be updated by manual input or through other input or automated process.

Tables E and F will be updated from the information found in the bibliography. This update may be quite complex because IS?N's for the references will have to be determined.

The determination of the IS?N for a reference may be accomplished by accessing the existing “Books in Print” web site.

The reference listing is usually found at the end of a text or journal, however in some works, it may be found at the end of a chapter. This is accounted for by searching for specific words such as “references” or by other appropriate rules that would be within the abilities of one skilled in the art.

### Results Pages

The results pages serve a number of purposes:

Allow the user to further filter the results tables by allowing them to select records from any of the tables.

Allow the user to “drill down” on a specific textbook or journal, and if available, on the specific passage(s) of interest.

Allow the user to order the text or journal online, if desired.

The results pages are described below:

### 1. Search Results

In a preferred embodiment, the Search Results screen will display a summary for the currently specified search criteria. The summary will preferably contain the following information:

Number of Titles meeting the selection criteria

Number of Authors whose works meet the selection criteria

Number of Publishers whose works meet the selection criteria

Number of Subjects that meet the selection criteria

Number of Passages that meet the selection criteria

Number of Reference texts or journals—references or reference texts/journals?

This screen will also contain a New Search button that will allow the user to conduct another search, based on new criteria. Every time a search is conducted using the search button, a new entry will be made into the Search History file. Preferably, whenever the New Search button is pressed, any existing results tables will be erased, and the entire database will be scanned in its entirety for matches.

On the other hand, the user may look at the other results pages (for instance, the Authors results page) and further narrow the search down by selecting a range of authors, and/or one or more specific authors. When this is done, the existing results tables will be used, and any such subsequent “narrowing down” will merely select subsets of the existing results tables.

### 2. Titles Screen

This screen is displayed if the user clicks on Titles in the Search Results screen. This screen will have “Next page” and “Prev page” buttons at the bottom, in the event that there is more than one screen's worth of titles. This screen will also contain an Only Selected button. The column headings will be “Title”, “Type”, “Author”, “Publisher”, and “Date”. If the user double clicks on an entry, they will drill down to the Title Information Screen (described below). The user may highlight individual entries, or ranges, using the standard Windows selection key conventions. Then, by pressing the Only Selected button, all unselected titles will be removed from all of the results tables. After this button is pressed, the user will be returned to the Search Results Screen. This button will be disabled if no selections have been entered.

In one embodiment, this information will be extracted from Table A of the ContentScan database, and sorted in descending order by search ranking. In one preferred embodiment, the search ranking will be calculated by applying this formula:

Search Ranking=(5−No. yrs old)+No. passages+No. titles ref'd in (either relevant titles or simply titles)

where:

No. of yrs old is the age of the current edition

No. passages is the number of passages returned by the search that are contained in this text

No. titles . . . is the Table A field

One of skill in the art would recognize that the above formula is exemplary only and is not meant to limit the invention they would recognize other alternatives and modifications.

### 3. Authors Screen

This screen is displayed if the user clicks on Authors in the Search Results screen. This screen will have “Next page” and “Prev page” buttons at the bottom, in the event that there is more than one screen's worth of authors. This screen will also contain an Only Selected button. The only column heading will be “Author”. If the user double clicks on an entry, they will drill down to the Author Information Screen (described below). The user may highlight individual entries, or ranges, using the standard Windows selection key conventions. Then, by pressing the Only Selected button, all unselected authors will be removed from all of the results tables. After this button is pressed, the user will be returned to the Search Results Screen. This button will be disabled if no selections have been entered.

### 4. Publishers Screen

This screen is displayed if the user clicks on Publishers in the Search Results screen. This screen will have “Next page” and “Prev page” buttons at the bottom, in the event that there is more than one screen's worth of publishers. This screen will also contain an Only Selected button. The only column heading will be “Publisher”. If the user double clicks on an entry, they will be sent to the publisher's web page. The user may highlight individual entries, or ranges, using the standard Windows selection key conventions. Then, by pressing the Only Selected button, all unselected publishers will be removed from all of the results tables. After this button is pressed, the user will be returned to the Search Results Screen. This button will be disabled if no selections have been entered.

### 5. Subjects Screen

This screen is displayed if the user clicks on Subjects in the Search Results screen. This screen will have “Next page” and “Prev page” buttons at the bottom, in the event that there is more than one screen's worth of subjects. This screen will also contain an Only Selected button. The only column heading will be Subject. The user may highlight individual entries, or ranges, using the standard Windows selection key conventions. Then, by pressing the Only Selected button, all unselected subjects will be removed from all of the results tables. After this button is pressed, the user will be returned to the Search Results Screen. This button will be disabled if no selections have been entered.

### 6. Passages Screen

This screen is displayed if the user clicks on Passages in the Search Results screen. This screen will have “Next page” and “Prev page” buttons at the bottom, in the event that there is more than one screen's worth of passages. This screen will also contain an Only Selected button. The column headings will be “Keyword”, “Title”, “Author” and “Page(s)”. If the user double clicks on an entry, they will be sent to the Passage Text Screen (described below). The user may highlight individual entries, or ranges, using the standard Windows selection key conventions. Then, by pressing the Only Selected button, all unselected passages will be removed from all of the results tables. After this button is pressed, the user will be returned to the Search Results Screen. This button will be disabled if no selections have been entered.

### 7. References Screen

This screen is displayed if the user clicks on Reference in the Search Results screen. This screen will have “Next page” and “Prev page” buttons at the bottom, in the event that there is more than one screen's worth of references. The column headings will be “Title”, “Type”, “Author”, “Publisher”, and “Date”. If the user double clicks on an entry, they will drill down to the Title Information Screen (described below) for that reference. Please note that the Only Selected button is not available in this screen.

### 8. Title Information Screen

This screen is displayed if the user double clicks on any entry in the Title Screen or in the Reference Screen. This screen will contain the following information for each title, if available:

Title

IS?N Number

LOC Information

Author

Publisher

Journal or Book

Synopsis

Condensed Table of Contents

Current Edition

Publish Date

Copyright Date

If the user clicks on Author, the Author Information Screen (described below) will be displayed. If the user clicks on Publisher, they will be taken directly to the publisher's web site.

Additionally, these buttons will preferably be displayed:

Index—Displays the entire index for the title (described below)

References—Displays the entire list of references for the title (described below)

Referenced By—Displays all works that reference this title (described below)

Purchase Online—Allows the user to purchase (to be added later)

View Jacket cover—Allows the user to view the jacket cover (to be added later)

### 9. Author Information Screen

This screen is displayed if the user double clicks on any entry in the Author Screen. This screen will display the Author's biographical information from Table G, if any. There will also be a Titles button that will display a screen containing a complete list of all catalogued works. Any entry on this screen may be double clicked to display the Title Information Screen.

### 10. Passage Text Screen

This screen is displayed if the user double clicks on a passage entry in the Passages Screen. If text is not available, this screen merely states that, and allows the user to return to the previous screen. If the text is available at no charge, its location is accessed, the text read, and displayed. If there is a charge, the user is so informed. If the user has not downloaded the ContentScan software, they are additionally informed that it is unavailable to them until they download the ContentScan programs. If the user has downloaded that software, then the charge is calculated and displayed, and the user is asked if they want to place that charge on their credit card. If so, a credit card charge will be processed for all such transactions when the session has ended.

### 11. Index Screen

This screen will be displayed when the user presses the Index button in the Title Information Screen. The entire Index will be displayed, using a multi-page format if necessary. If an entry in this screen is clicked, the Passage Screen for that entry will be displayed.

### 12. References Screen

This screen will be displayed when the user presses the References button in the Title Information Screen. All References for the title will be displayed, using a multi-page format if necessary. If an entry in this screen is clicked, the Title Information Screen for that entry will be displayed.

### 13. Referenced By Screen

This screen will be displayed when the user presses the Referenced By button in the Title Information Screen. All References for the title will be displayed, using a multi-page format if necessary. If an entry in this screen is clicked, the Title Information Screen for that entry will be displayed.

### 14. Purchase Online

This screen will be displayed when the user presses the Purchase Online button in the Title Information Screen.

### 15. View Jacket Cover

This screen will be displayed when the user presses the View Jacket Cover button in the Title Information Screen.

### Section 3

### Programming Consideration Related to Preferred Embodiments of the Present Invention

### Introduction

ContentScan.com (used herein to refer generally to an electronic or Internet based portal) is a new electronic service provided by the present invention that allows users to search for textbooks or journals containing information that the user needs for research purposes. Existing English-language textbook titles, tables of contents, indices, glossaries, and bibliographies will be represented in the ContentScan database. Digitized full-text pages may optionally be made available by arrangement with the publisher or second party content sources. ContentScan.com will be powered by the ContentScan search engine.

The ContentScan.com site will allow any user to submit search criteria to the ContentScan search engine. The search engine will convert the search string to a database query and will produce results based on comparisons between indexed components of each book (Title, Library of Congress (LOC) data, table of contents (TOC), Index, References and Glossary). These results will then be returned to the user.

Users will be allowed to submit a variety of criteria, including ISBN Number, key-word search terms, publisher information, Library of Congress subjects, etc. ContentScan will give the user detailed information concerning all texts that meet the search criteria. The results pages will allow the user to further narrow the search by adding more specific search criteria or by selecting a given title for closer examination. The user may also expand the search from a specific title by viewing its bibliographic references or by viewing documents which reference it.

ContentScan will update its database with book data from publishers by either uploading standard ONIX XML data or interacting through a special strategic partner HTML interface to create and update document information.

### Searches

### Standard Search

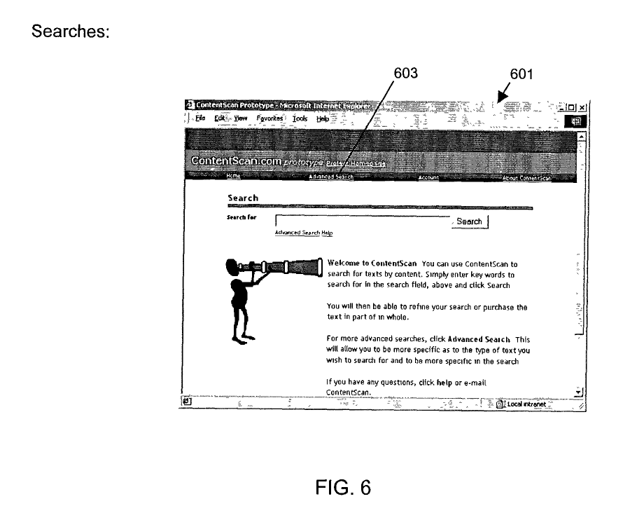

As shown in FIG. 6, the Standard Search is incorporated into the Home page of the ContentScan website or internet portal contemplated by the present invention. It allows searches by Title, Author, Key Word or ISBN/ISSN. Standard Search has a link 603 to the Advanced Search page.

It is also possible that this page will have login and password fields allowing the user to access search capabilities, user registration and credit card information stored on the user's computer.

In one preferred embodiment, included in the opening page of ContentScan.com will be:

a. Logo

b. Simple Search Parameter Dropdown-menu (Author, Topic, Title, ISBN)

c. Simple Search Field

d. Advanced Search Link

e. Filter Options for simple search results

i. Ranking options

1. Relevance

2. Date

ii. Screening options

1. Digital Availability

f. Help Link (information on Search Techniques)

g. More info/about link

2. ContentStar login and password fields

3. ContentStar link

4. Brief Description of ContentScan and ContentScan.com or About link covering the following:

a. Comprehensive search of scholarly/scientific publications

i. Peer Reviewed

ii. Published texts and/or journal articles

b. Identifies the most relevant documents and passages

c. “Text mapping” by Indexed keywords

i. Lists, in order of occurrence, all indexed words appearing in the document within “X” number of pages of the search terms. Useful for determining the context of search term usage when full text is not available.

d. Bibliographic Search capabilities

e. Purchase Options

f. Benefit of login registration/ContentStar

5. Copyright info.

While website or internet portal interface may be considered as a separate product with a separate technical specification, a brief discussion is included here because it may be integrated into ContentScan and because the two are closely related.

As alluded to above, the website or internet portal interface provides advanced search capabilities with results tailored to the specific needs of registered users. Users register their area of expertise, level of expertise, and potentially the type of organization/institution with which they are affiliated. The present invention then “learns” from the search patterns of each type of user by including the number of times that documents are accessed by users with similar profiles in the prioritization algorithm.

In one embodiment, the website or internet portal home page includes the following components:

a. Logo

b. Username field

c. Password field

d. Login Button (link)

e. About (link)

f. ContentScan Home (link)

g. Registration Fields

i. Login/username

ii. Password

iii. Password confirmation

iv. Email address (in case password is lost)

v. Level of Expertise

1. Undergraduate

2. Upper-division Undergraduate (Junior/Senior)

3. Masters

4. Ph.D.

5. Post Doc.

6. Professor

7. Practitioner

vi. Area of Expertise/Specialization

1. Medical

2. Biology, non-medical

3. Chemistry

4. Physics

5. Oceanography

6. Geography

7. Etc.

vii. Organization Affiliation/Institution Type

1. Government Agency

2. Gov. Lab

3. Think Tank

4. Consulting

5. Public University

6. Private University

7. Private Research and Development Inst.

8. Non-Profit

9. Private Enterprise

h. Privacy Statement

### Advanced Search

The Advanced Search page allows much more control to the user and specificity in the searches performed.

When the user has entered criteria and clicks the Search button to perform the search, the criteria will be saved as a cookie on the user's machine (if possible with their set-up) and the data will be passed to the Search Engine for processing. In one embodiment, a maximum of 20 searches will be saved in this way for future reference. There will be a Search History link on the Advanced Search page that accesses the last 20 (max) cookies saved. An Account link be inserted to this page that will allow the user to access the registration and credit card information stored in a file on the user's computer. This information will also allow for enhancement of search results based user profile.

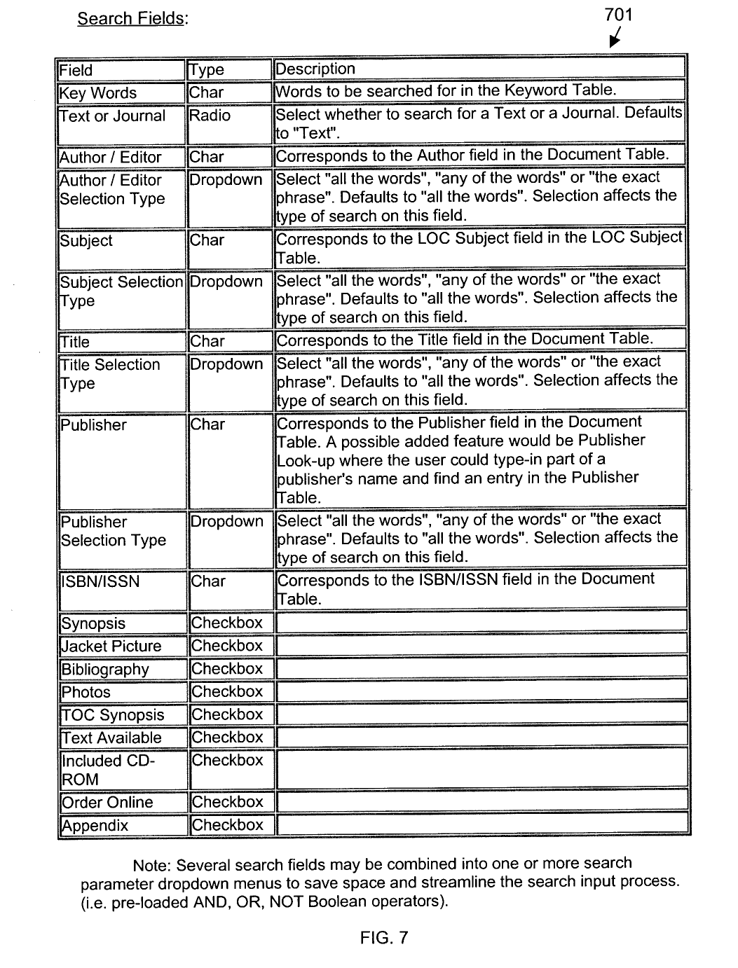

The user may also have the ability customize the search algorithm by selecting whether or not to include several optional parameters in the search algorithm's prioritization/ranking of the results. An exemplary list of search fields is shown in table 701 in FIG. 7.

### Design Parameters

The search page(s) should be engineered to work well with all common browsers. It should use as little bandwidth as possible to facilitate quick display. The design should be conventional, easy to understand and aesthetically pleasing to a wide variety of people.

The page should be kept as simple as possible to meet the above design goals.

In one embodiment, the search page will be an ASP page and will contain both client-side and server-side scripts (programs). An example of a client-side script would be logic to save searches as “cookies” on the client machine. This script would rotate the ten most recent searches in the cookie document. A server-side script would be a program to pass search parameters to the Search Engine.

### Results Pages

### Overview

The results pages will serve the following purposes:

Allow the user to further filter the results tables or views by allowing them to select records from any of the tables.

Allow the user to “drill down” to a specific textbook or journal, and if available, to specific passages of interest.

Allow the user to expand the limits of a search by presenting a “similar titles” option as well as linked reference information for each returned title.

Allow the user to order the text or journal online.

The system will be designed to work with all common, known web browsers or other user interface mechanism (for example, voice activated, PDA, or cell phone based interfaces), independent of the underlying operating system.

### Main Search Results Page

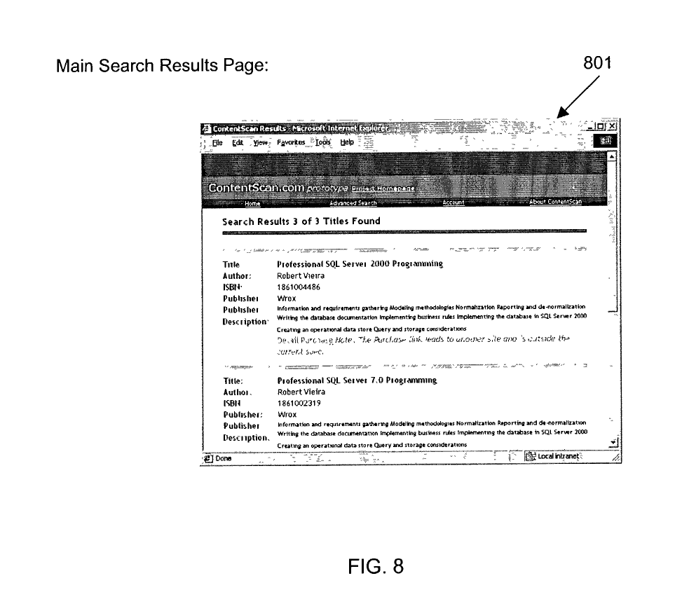

An exemplary Search Results page 801 in FIG. 8 displays a summary for the currently specified search criteria. This page allows the user to examine the resulting titles and includes statistical data such as how many titles were found. The user is able to refine the search to yield fewer matching titles or drill into a particular title for detailed information and additional links.

The main search results page will contain in one embodiment:

1. Number of titles meeting the selection criteria.

2. Number of Results pages used to hold the search results.

3. Links to each page in the results set.

4. A link to a new search.

5. A link to Refine the current search.

6. Show a series of selected Titles with detail as shown, below and check boxes next to each to reserve selected results to:

i. Save in user file/profile

ii. Export to printer

iii. Download in useful format (e.g. endnote)

7. For each returned Title format an HTML table cell group showing:

a. Title (link to Title Detail Page)

b. Author/Editor names (link to Author/Editor Page)

c. Result Rank Number

d. ISBN

e. Publisher

f. Digital Availability (Y/N)

g. Link to Purchase Options Page

8. Removed Un-Checked Button

9. “Reprioritize Results” Drop-Down Menu

a. Date

b. Relevance

c. Alphabetical (by Author/Editor or Title)

d. . . .

10. Each search page will also include a search field for further searches using ContentScan.

### Title Detail Page

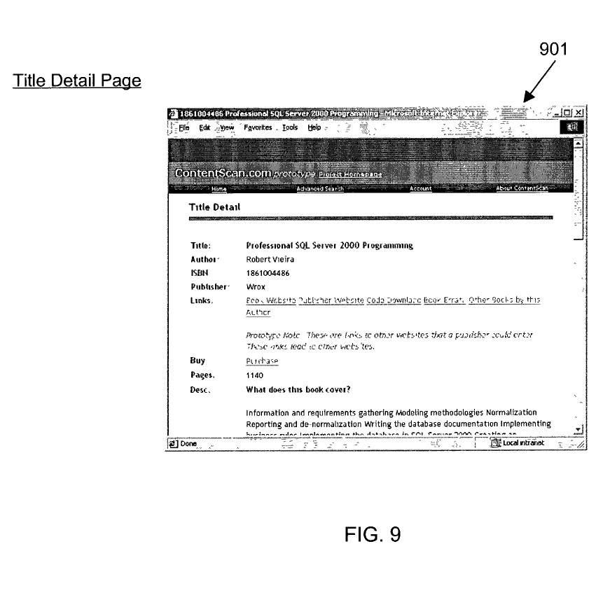

An exemplary title detail page 901 in FIG. 9 provides a drill-down to detail, displaying all information known about a particular title.

1. Title

2. All Author/Editors (links to Author/Editor Pages)

3. # of Citations (link to list of citations, w/passages listed if included in citation)

4. # of Times Cited (link to list of titles that cite the document)

5. Publisher's Description/Abstract

6. Number of Pages in the Title

7. ISBN/ISSN

8. Publisher

9. Link to Detail

10. Link to Purchase Options page

11. Search field for passages within the document (Search field or link)

12. Search field for related titles (Search field or link)

13. Table of Contents

14. Additional Publisher links

When a Title Detail page is selected, the system will increment the Times Viewed field for the title in the Document table.

### Design Parameters

The results page 901 should be engineered so it will run on all common browsers. It should use as little bandwidth as possible so it will display quickly. The design should be conventional, easy to understand and aesthetically appealing to a wide audience.

The search results page should avoid showing anything that does not directly relate to the search in question because this can confuse and distract people while they are carrying out what is a very specific activity.

The search results page should preferably use a single-column layout.

The number of documents found could be displayed between the top search box and the actual results.

To the extent that it is possible, search results must show results in order of relevance.

The search keyword(s) used in the search process could be displayed.

Search results should not show duplicate entries of content. This includes multiple URLs pointing to the same piece of content.

The search results should be broken down into batches of a certain number, such as 10. It is possible to allow the user to override the default number of records to be displayed per page.

There should be a set of links to the other batches at the end of each batch of results up to the 10th batch (e.g., 1 2 3 . . . 8 9 10). The first batch should not be hyper-linked. It can be in a different color to show readers that this is where they currently are.

When readers click on the 10th batch, they should be presented with a 11-20 set of batches at the bottom of the page (e.g., 1 2 3 . . . 18 19 20).. When they click on the 20th batch, they should be shown 11-30 and so on in rolling batches of 20.

“Next” and “Previous” links should be provided. “Next” links you to the next page, and “Previous” to the previous page in the series of results pages.

### Author/Editor Page

These pages provide information on publications by specific authors/editors of interest. It is opened either by conducting a search based on the author/editor search parameter or by selecting the author of a document from the Text Detail page. It lists all publications in the database where the individual of interest was an author or editor. These results should initially are listed by date but should have the same reprioritization options as the standard results page.

### Purchase Options Page

This page provides the gateway to the content or full text of interest. It can be linked to from any of the results pages or from the Title Detail page. While publisher direct purchase options should be prominently displayed, alternative purchase options should be made available. This page preferably contains the following components:

1. Basic Citation of document to be purchased

a. Title

b. Authors

c. Publication Date

d. Etc.

2. Publisher Provided purchase options

a. Hard Copy (w/price and link to publisher)

b. Digital format availability (w/price and link to publisher or internal)

c. Passage/Partial text purchase options (w/price and link internal or publisher)

3. Hard Copy price comparison (link, internal)

4. Digital format/partial text price comparison (link)

In one embodiment, the technologies to be used in the Search Engine are all mainstream Microsoft and industry-standard based. The Internet site server is proposed to be the Microsoft IIS (Internet Information Services) or Microsoft Internet Site Server. The OS (Operating System) used for servers is proposed to be Microsoft Windows 2000 Server or Microsoft Windows 2000 Advanced Server. The database will be hosted on a Microsoft SQL Server 2000.

A variety of technologies will be employed to create an efficient and cost-effective total system. By centering on Microsoft products, the integration of the various components is better facilitated. However, on the client side (that is to say the user's Internet browser and computer system) the system will be engineered to be as flexible as possible.

The IIS server will use ASP pages to query the SQL database and return results to the user in the form of HTML pages.

In one embodiment, the Search Engine is written in a combination of Visual Basic, T-SQL, XSL and XSLT. It creates intermediate data sets in XML that can be further processed to refine a search or be analyzed for sort weighting.

### Search Sort Weight

It is preferred that the titles that are likely to be of most interest to the user are displayed near the top of the returned results table. This is one of the key features distinguishing ContentScan from other bibliographic information retrieval systems—relevance determinations based on incidence and weights assigned to book structural components. Since there are several factors that can affect the desirability of a particular title, ContentScan will assign “sort weight” to book titles based on several criteria and then sort the titles selected in a search by this “sort weight”. Titles that have the greatest weight will appear at the top of the returned HTML Results pages.

Since sort weight is based on multiple algorithms, it is necessary that the overall search engine be modular (could also be based on a genetic algorithm). Actual weighting of results will be an adjustable summation of the relative weighting of different weighting programs which are combined based on criteria determined by ContentScan.

The Search Engine has an overall controlling program that will run other programs to create the various weightings. This “master program” will then combine the various weightings generated from values gathered from a SQL document table.

When a search is conducted, a preliminary results table could be created and then analyzed. Multiple entries of the same title would be consolidated into the final results table as a single entry and proportionate weight added to titles that met multiple search criteria or met specific criteria more directly. Then each title would be examined and additional weight added for other criteria such as “TimesViewed” or “XRefed”.

### Examples of Weighting Criteria

The following are some of the factors that will be used to calculate Sort Weight:

Keyword Location and Frequency: Weight is added to a document based on where a particular keyword occurs in a document and the number of times it appears in each possible location. For example, more weight would be added if a key word appears in the title of a document than if it appears the same number of times in the index, as incidence of a keyword within the title increases the chances of finding relevant content within the book than equal incidence levels within the index. Weight would be proportionately increased based on the number of occurrences in each location. Locations within the book or journal to be included and weighted independently include the title, table of contents, index, glossary, Library of Congress data, and titles of documents in the bibliography.

Number of User Criteria Met: Weight is added based on the number of user-entered criteria that were met. This presupposes that not all criteria must be met, but a percentage of criteria met for an item to be included in the result set. This would allow a return even if not all criteria were satisfied. This would include the number of specified key words that were found in a particular book.

XRefed: The number of times that a title is cross-referenced in the DocXRef table.

Document.MarketingWeight: Arbitrary sort weight added to a title for marketing reasons.

Document.TimesViewed: This is a field in the Document table that is incremented whenever a Title Detail page is viewed.

DocumentTimesPurchased: This is a field in the Document table that is incremented whenever a document or passage from a document is purchased through a ContentScan.com referral.

This weighted sorting of search results has a relative performance penalty compared to straight sorting of search results based on a field value, however, this is a valuable feature—a reason for users to use the service.

The proportion of weight given to each factor needs to be readily adjustable. This will allow ContentScan operators to make the sorting of results more meaningful and therefore valuable to the user. The amount of weight given to titles based on search criteria met would likely be high and then additional criteria factored in. So, if ten titles actually met all search criteria, those titles would be weighted by the other factors.

One possible sorting weight scheme would be to assign a certain weight, say “50” for each search criteria met. Then add say “2” for titles that had many detail hits and “2” for titles that were referenced often. This would sort the titles mainly by search criteria met and within that sort by other factors. The exact values that would be used would be contained in a table or tables and will be optimized as would be recognized by those skilled in the art.

### XML and the Search Engine

In addition to being used in ONIX (stands for Online Information eXchange which is a standard format that publishers use to distribute electronic information about their books), XML is also a technology that will be used to create and operate ContentScan.com.

Since data is retrieved from a SQL database, acted on further and to create formatted results for the users, there is a need for a way to temporarily store and manipulate results data. XML provides a standard and powerful means to carry these tasks out. The system searches for matching titles in the database and creates an XML document. The system then further manipulate this object to achieve the selected and weighted list of results for the user. An initial HTML page is then created referring to this document and the user is able to view the results in a series of such HTML pages, each of which are generated from this XML document. It is possible that as the user refines a search, this object would be refined and represented to the user.

In one embodiment, the manipulation and transformation of the XML object data would be done through XSLT, a transformation language for XML documents.

If the user refines a search, the system will examine the search to see if it has become more or less restrictive. If it is more restrictive then the XML document would be refined. If it is less restrictive, a new search of the SQL database would be performed.

### Information Flow and Processing: Exemplary Search

As shown in the flowchart of FIG. 2, the user enters search criteria on an ASP form in step 201.

When the user submits the data by pressing the “Search” button, the data is transmitted to the server as a call to another ASP form 204 that has program code embedded in it.

The embedded program parses and passes these parameters to a VBS (Visual BASIC Script) program on the server that creates a SQL Select statement (or more than one) in steps 203 and 205 and executes it on the SQL server 208 in step 207.

In step 209, an XML document 210 is created from the results and then the XML result set is further refined using the ContentScan document weighting algorithm in step 211. This further refinement includes removing duplicate records and assigning sort weight to each record.

In step 213, an HTML document 212 is created from the XML document using XSLT and VBS. This document is then returned to the user's browser at step 215.

If the user further narrows the search in step 217, the SQL database would not be searched. The XML document would be searched and modified to reflect the reduced matching data.

### Design Parameters

The search engine is written using standard systems and tools that are familiar to those skilled in the art. The systems and technologies employed must be current so the system will not need to be redesigned to accommodate anticipated traffic increases.

The XML-based results document should be sorted in relevance order, using the ContentScan document weighting algorithm. It should contain no duplicate entries.

While an initial implementation may not have many speed optimizations, it must be designed so such optimizations can be added. This is one reason for selected XML to hold initial search results. After the initial SQL search is completed (on the SQL server) the search engine can refine the results set (XML document) on the Internet server. Additional optimizations may include keeping XML documents for a certain period of time in case the user wants to revisit a certain search.

### Database

In the preferred embodiment, the database will be hosted on a Microsoft SQL 2000 server, hosted on a Microsoft Windows 2000 system. This will integrate well with the Microsoft Site Server and will be accessed using ASP (Active Server Pages) on the server.

The SQL 2000 server is scalable, allowing for growth as the performance needs increase with increased system usage. By using an all-Microsoft solution, integration issues are minimized and the software development cost is reduced in relation to a mixed-vendor solution.

SQL is by far the most common and powerful solution for hosting large database applications. If offers very powerful facilities to organize and access data using T-SQL (Transaction Structured Query Language). T-SQL is the Microsoft version of SQL. It is a non-procedural database language. Where in a procedural language, the precise process of retrieving desired data is described in the form of a program, in T-SQL (and other SQL versions) the result is described and the server itself actually constructs the process of retrieving and organizing the data as specified.

It should be noted that in the Microsoft product line, SQL 2000 refers to a server and T-SQL to the SQL language run on the server.

Additionally, SQL offloads the work needed to build a results table to dedicated hardware, freeing the Internet server to process user requests.

The Internet site server interacts with the user and receives a data request in the form of an ASP page. This page will contain the user's parameters for a particular search. This set of search parameters will be stored in the user's machine in the form of a cookie in case the user wants to retrieve and alter the search at a later date. The parameters are then passed to a computer program on the IIS server. The program analyses the parameters for validity and then constructs a T-SQL program that is executed on the SQL 2000 server. The resulting table (SQL always expresses datasets in the form of tables) is then parsed by another program and a Results Page is constructed. The results table is kept in storage for a specified period of time, during which the user can interact with it using ASP pages. For instance, the first results page will show a certain number of records and if the user desires to view additional data, a “next” link might be selected.

### Tables

Tables are the basic way data is stored on a SQL server. In one preferred embodiment, the following are the basic tables needed for ContentScan.com.

Most information will be transferred to the ContentScan database, using ONIX, which is a publishing industry standard based on XML.

A program is provided to import data from an ONIX file to the ContentScan database. Developing such a program based on the information provided herein is within the abilities of one skilled in the art.

### Document Table

Each catalogued textbook and journal.

| Field | Description | Type | Length |
|---|---|---|---|
| Title | Title of Work | Char | 100 |
| Subj. Index | Subject Index of Work, retains | Char/Int | ? |
| | hierarchical structure | | |
| References | Titles of all references | Char | ? |
| Glossary | Glossary of Work | Char | ? |
| DocumentID | (Key) Record ID | Int (Auto) | — |
| ISBN | ISBN Number | Char | 10 |
| LatestEdition | Latest edition | Char | 10 |
| PubDate | Date of publication | Date | — |
| PublisherID | Publisher | Int | — |
| DateUpdated | Date publication was last | Date | — |
| | updated | | |
| TimesViewed | Number of times the title was | Int | — |
| | viewed in detail on | | |
| | ContentScan. | | |
| TimesPurchased | Number of times the title was | Int | — |
| | purchased through a | | |
| | ContentScan referral. | | |
| MarketingWeight | Arbitrary sort weight added for | Int | — |
| | marketing reasons. | | |
| Author(s) | Author name links to additional | Char | 100 |
| | works by selected author. | | |

### Document Detail Table

Document detail.

| Field | Description | Type | Length |
|---|---|---|---|
| DocumentDetailID | (Key) Record ID | Int | — |
| DocumentID | Foreign key into Document | Int | — |
| | table | | |
| PublishersSynopsis | Publisher's synopsis | Text | — |
| LOCInfo | LOC information | Text | — |
| CondensedTOC | Condensed Table of Contents | Text | — |

### KeyWord Table

Keywords contained in all texts and journals having records in the Document Table.

| Field | Description | Type | Length |
|---|---|---|---|
| KeyWordID | (Key) Record ID | Int (Auto) | — |
| DocumentID | Foreign Key to Document | Int | — |
| | record. | | |
| Word | Word to Index, Title, TOC, | Char | 35 |
| | References, etc. | | |
| PageNum | Page number reference | Int | — |
| PageEndRange | Where PageNum is the | Int | — |
| | beginning of the range. | | |

### LOC Subject Table

Consists of LOC Subjects for all texts and journals having records in the Document Table. (LOC: Library of Congress)

| Field | Description | Type | Length |
|---|---|---|---|
| LOCSubjectID | (Key) Record ID | Int (Auto) | — |
| (Key) | | | |
| DocumentID | Foreign Key to Document | Int | — |
| | record. | | |
| LOCSubject | LOC Subject | Text | — |

### Publisher Table

All Journal and Textbook publishers: additional fields will be added to this table, as required.

| Field | Description | Type | Length |
|---|---|---|---|
| PublisherID (Key) | Record ID | Int (Auto) | — |
| Name | Publisher name | Char | 50 |
| Website | URL | Char | 80 |

### DocXRef

Consists of ISBN Numbers that reference each text or journal in Document Table. This table will allow the user to view each of the texts or journals that refer to a particular text or journal in their bibliographies.

| Field | Description | Type | Length |
|---|---|---|---|
| DocXRefID (Key) | Record ID | Int (Auto) | — |
| ReferringISBN | ISBN of document making | Char | 10 |
| | reference. | | |
| ReferredISBN | ISBN of document being | Char | 10 |
| | referred to. | | |

### Author Table

Contains biographical information, if available, for each Author having a catalogued Journal or Text.

| Field | Description | Type | Length |
|---|---|---|---|
| AuthorID (Key) | Record ID | Int (Auto) | — |
| LastName | Author's last name. | Char | 30 |
| FirstName | Author's first name. | Char | 30 |
| MiddleName | Author's middle name. | Char | 30 |
| Further Works | Linked list of publications by | Char | ? |
| | specific Author | | |

### AuthorLink Table

Since there can be multiple authors for a given document, a link table is provided to associate Author records with Document records.

| Field | Description | Type | Length |
|---|---|---|---|
| AuthorLinkID | Record ID | Int (Auto) | — |
| (Key) | | | |
| AuthorID | Author Record ID | Int | — |
| (Foreign Key -> | | | |
| Author Table) | | | |
| DocumentID | Document Record ID | Int | — |
| (Foreign Key -> | | | |
| Document Table) | | | |

### User Table

This keeps track of user information. Fields can be added to this table as required. The UserID is also embedded in the client-side cookie.

| Field | Description | Type | Length |
|---|---|---|---|
| UserID (Key) | Record ID | Int (Auto) | — |
| First Name | User's first name | Char | 35 |
| Last Name | User's last name | Char | 35 |
| Field | Drop Down Menu based field | Char | ? |
| | category | | |

### Design Parameters: Database Normalization

The database is designed and implemented using the principals of database normalization. These are logical rules that allow a database to be logical and efficient. When so designed, it is likely that the system will have fewer problems and will need fewer future engineering changes. While applicable to most database systems, database normalization is particularly applicable to SQL databases. The T-SQL language is designed to be most effective on normalized databases.

### First Normal Form

Eliminate repeating groups in individual tables.

Create a separate table for each set of related data.

Identify each set of related data with a primary key.

### Second Normal Form

Create separate tables for sets of values that apply to multiple records.

Relate these tables with a foreign key.

### Third Normal Form

Eliminate fields that do not depend on the key.

### Fourth Normal Form

In a many-to-many relationship, independent entities cannot be stored in the same table.

Most information will probably be transferred to the ContentScan.com database, using ONIX, which is an industry standard based on XML. In addition, a web crawler may also be used to acquire information into the database.

### Data Input

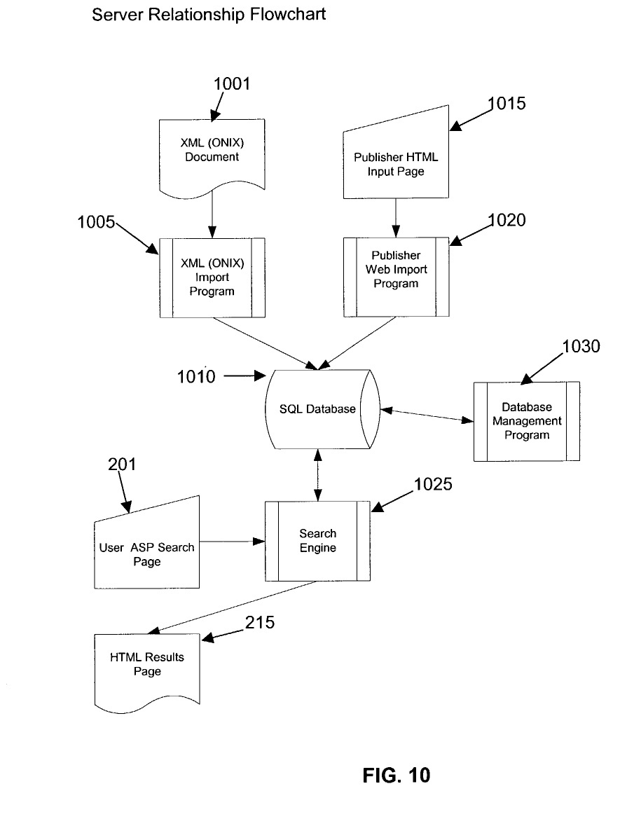

As shown in FIG. 10, data can be entered into the ContentScan system by various means including ONIX XML, web data entry or custom data conversions.

One of the means to populate ContentScan is via ONIX standard XML-based documents 1001, a book industry data exchange standard that uses XML technology. XML is a mark-up language that can be used to create standard data exchange formats. The ONIX standard uses XML as the basis for standard book data exchange.

In addition to using ONIX, in one aspect of the present invention ContentScan.com is able to maintain its database 1010 automatically from publishers' databases. For example, a publisher HTML input page 1015 provides access to a Publisher Web Import Program 1020 that updates the database 1010 managed by a database management program 1030.

One way to update ContentScan.com's database 1010 would be for a publisher or agent to submit an ONIX (XML) document to ContentScan.com via a password-protected web page that is imported using an XML (ONIX) Import Program 1005. This interface would allows a publisher to autonomously add to and maintain their book data easily with little effort. This presupposes that the publisher already has created an ONIX document for other purposes.

The present invention also contemplates creating custom imports for publishers that do not adhere to the ONIX standard. This may not be necessary, however, as ONIX appears to be a growing standard. The ContentScan search engine 1025 interacts with the SQL database 1010 to receive user input 201 and provide results 215 to a user in accordance with the searching and ranking techniques provided by the present invention.

### Hardware and Software Requirements

ContentScan has been designed to run on standard hardware using standard software. While other systems were considered, at this time, an Intel-based Microsoft solution is probably the best solution.

The system would run on standard Intel/PC-based servers. It could be scaled from a single server up to an array of servers sharing an increased load.

### Section 4

### Examples of Implementations of the Present Invention

### The Database

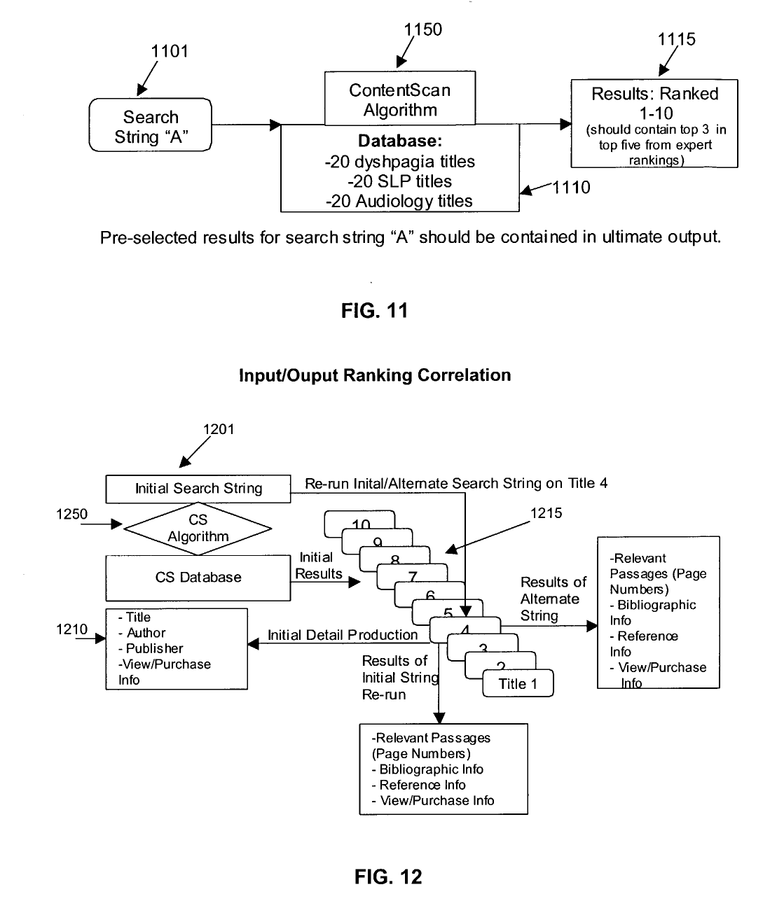

As shown in FIG. 11, in one exemplary implementation, the database consists of each of approximately 60 including ˜20 dysphagia texts (see table 1 below), ˜20 audiology texts, and ˜20 speech language science texts in the ContentScan database 1110. All information for each text is present within the database for each of these texts.

The information contained in the speech language science texts overlaps somewhat with the information in both the dysphagia and audiology texts while there should be minimal overlap between the information in the dysphagia and audiology texts. This database 1110 allows search strings targeted towards either dysphagia or audiology to be tested against documents specific to the topic of interest, documents related but not germane to the topic of interest, and documents unrelated to the topic of interest. This design provides a challenging test environment similar to the ultimate database. It is necessary to have complete information for each title present within the database in order to ensure fair measure of the algorithm's selection ability. This placebo-like application of variably correlated texts proves ContentScan's ability to establish a direct linkage between relevant titles and corresponding search strings.

### The Search Strings

Test search strings 1101 are developed by several groups of experts located around the country practicing in the areas of dysphagia and audiology. These experts generate test search strings prototypical of those conducted by clinicians and researchers. Each test search string consist of a series of key words designed to target a specific topic or body of information. Additionally, the groups of experts clearly define the topic or body of information. For each group of experts, one individual does not participate directly in the generation of the search strings. Rather, this individual will review the search strings to ensure quality, in terms of relevance and specificity of the key words to the information of interest, and rank the texts included in the database, and passages within the top three ranked titles, for each search string based on their relevance to the information of interest.

### Output

The output of the ContentScan system consists of a rank ordered listing 1115 of relevant documents for each search string using the ContentScan algorithm 1150 provided by the present invention. These results present each of the top three pre-ranked titles within the top five listed search results. In addition, intra-title searches should present the most highly ranked passages for each search string.

### Intra-Title Navigation

As shown in FIG. 12, an initial search 1201 using ContentScan will produce a list 1215 of texts ordered by relevance to the search string. The user will be able to select a single text from within this list and search it based on the same key words, or based upon a new search string. This intra-title search will produce passages within the selected text worth pursuing using data from the subject index and table of contents. The user can select a “map” of those passages or a list, in order of incidence, of other indexed words appearing in that passage. If permitted by the content source, the user may also browse the actual content of the passage.

### Inter-Title Navigation

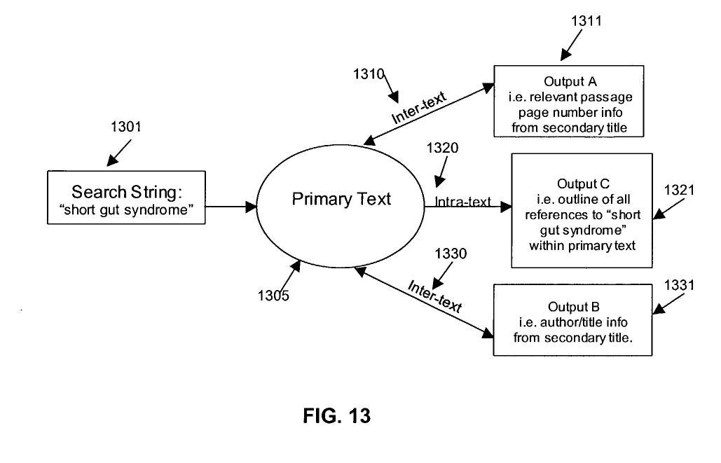

As shown in FIG. 13, the model also provides the means to navigate beyond the selected book. If a primary title 1305 is identified, the user will be able to expand the limits of the search to other similar titles. This expansion will be accomplished using reference information and LOC data from the initially selected text.

The model addresses intra-text searches 1310 in the following manner. In 1320, the above mentioned experts identify passages or page ranges most relevant to selected search strings within a specific text and then rank order these documents in much the same manner as the texts themselves were ranked in output 1321. Use of the dysphagia titles will allow for expansion within the additional 19 titles not used as the primary text. Expansion allows for access to bibliographic, reference and actual content material within the other titles relevant to a given search string. There are at least two ways that inter-text searches can be accomplished:

1. Perform an inter-text search 1310 using information within the ContentScan database for that title to output 1311.

2. Search 1330 within the title for references relevant to the search string to output 1331.

### Results

Results of keyword based searches provide the following information to the user:

1) The title of individual relevant texts ranked based upon the ContentScan algorithm.

2) Author information for each title.

3) ISBN information for each title.

4) Title itself should be a link to further information (e.g. TOC listing, Pricing comparisons, publisher site etc.)

5) Brief summary of title provided by publisher within ONIX framework.

From the title list mentioned in number 1 above, the user will be able to select a title(s) upon which to focus. This can be accomplished by an “Only Selected” feature which will remove all unselected returned titles. The user will have two options regarding searching this title/set of titles:

1) Search using existing keywords/search string.

2) Search using novel keywords/search string.

The user will also have the option of running an intra-text search or an inter-text search.

### Intra-text (1320)

Will produce relevant passages and a map of passages within a selected text relevant to the search string (output 1321).

### Inter-Text (1310 and 1330)

Will expand the search to titles referenced within the selected text with immediate relevance (as indicated by keyword match/comparison within multiple sources i.e. title, author, references, LOC data) to the search string. By searching within the references of secondary titles, the search will produce a list of titles that will remain targeted to the initial search string (see 1311 or 1331).

### Algorithms

Although ContentScan allows for searches based upon more parameters than keyword/subject (e.g. author, title, publisher, ISBN/ISSN), one aspect of present invention to novel algorithms associated with keyword/subject searches. Three potential algorithms for the ContentScan search protocol are proposed here: the Hierarchical model, the Absolute Value Model, and the Rank-Order Model.

### Subject/Keyword Search: Hierarchical Model

The hierarchical model is based upon a hierarchy within the title matter (i.e. index, TOC, references etc.). It is rigid in its sequential nature as relevance of criteria is established in advance by programmers. Search strings are evaluated within the most relevant criteria (e.g. index matches) first. Titles remaining are then evaluated based on the second most relevant criteria (e.g. TOC data). This process continues through each of the criteria with most relevant titles emerging in the end.

### Example

Once a keyword is entered, the algorithm will initially scan indexes (Table B in Section 2 earlier herein) within the entire database. Returned hits matching the keywords will create a secondary temporary table from which further selection will occur. Within this table, titles will be ranked according to incidence of keyword within the index. Next, presence of keywords within reference data (Table B) will allow for further limitation of results field. Keyword presence in main titles and sub-headings will then further streamline the result pool. Matches within the references of remaining titles will determine the ultimate rankings. Finally, remaining titles will be ranked descending chronologically. It is important to note that this is only one sequences of many possible sequences to be used for production of the most relevant search results. However, the following matter should preferably be included in a search:

1) Index

2) TOC

3) Title

4) Sub-Heading Titles

5) References

6) Date of Publication

Secondary searches of specific titles/pools of titles could use:

1) Bibliographic information for expansion of inter-text searches.

2) Author Weighting—Based on incidence of Author name within references of selected titles and passages.

### Subject/Keyword Search: Absolute Value Model

The absolute value model uses the keywords to count each criteria individually and then sums the amount of hits returned within each category to produce the most relevant titles. No hierarchy is used within the criteria, no preference is given to any criteria. Instead, an absolute value is determined based upon the number of hits for keywords within the tables for each criteria.

### Example

Search string is evaluated within the Index, TOC, Title, Sub-Heading, and References tables individually and simultaneously. Each title is given an aggregate score based on a summing of scores within each table. Most relevant titles will correspond to titles with the highest sum and titles would be listed in descending order. This model can also accommodate weighting of each criteria in order to determine most relevant titles. For example, if the table containing all indexed words is weighed heavier than others, then perhaps a single hit would represent two points instead of one.

### Subject/Keyword Search: Rank-Order Model

The rank-order model allows for competition within the body of each table. Keywords will be evaluated within each table and a rank would be ascribed to titles individually within each table. Numerical rankings would then be summed to produce the most relevant titles. In the rank-order model, lowest numerical values correspond to highest degree of relevancy. Titles will be therefore be listed in ascending order.

### Example

When keyword is compared to each criteria table individually. The following results occur:

Index Table:

Title A-1

Title C-2

Title F-3

Title S-4

TOC Table:

Title C-1

Title A-2

Title S-3

Title F-4

Reference Table:

Title A-1

Title F-2

Title C-3

Title S-4

Title Table:

Title A-1

Title C-2

Title F-3

Title S-4

Sub-Heading Table:

Title C-1

Title A-2

Title F-3

Title S-4

| Totals: | Title A | Title C | Title F | Title S |
|---|---|---|---|---|
| | 7 | 9 | 15 | 19 |

The most relevant title is therefore Title A.

The rank-order model easily allows for weighting of various criteria. For example, in order to give index ranking higher precedence than other rankings, other rankings would be numerically increased in value.

### Second Embodiment

Another embodiment consistent with the principles of the present invention is discussed herein with respect to FIGS. 14-20. In this embodiment, the structural/spatial characteristics of books preferably resolve into five distinct categories:

### 1.0 Glossary for Second Embodiment

1. Containment hierarchy: the authors provide organization of their materials into chapters, sections, subsections, . . . through to individual paragraphs. In addition to the text of the paragraphs themselves, chapters and sections often have rubrics as titles. A feature of present invention is the length normalization of keyword occurrence frequency within various levels of the containment hierarchy; see subection 2.7 of the second embodiment further herein.

2. Subject index: a list of topics covered by the text, together with page numbers on which these topics are covered within the text.

3. Bibliographic citations: references made by the author of this book to prior writings. Typically these citations are collected at the end of the entire volume, but collection at the end of individual chapters is common as well, especially in multi authored collected editions.

4. Glossary: key terms with definitions provided by the authors

5. Interior pages: All pages not part of the “front-matter/back-matter” categories listed above.

As shown in FIG. 14, these components are placed within the context of a Dome system connecting users 1405 to materials, for example, the book 1410 and the various associations with the book data, such as, author, index, chapters, LOC information, etc.

### 2.0 Retrieval Representations, Algorithms, and Interactions

### 2.1. Table of Contents (TOC)++(or Expanded TOC) Representation

In order to be robust in the face of widely varying book formats, the present invention uses the TOC as the minimal retrieval unit. In particular, full text of interior pages (i.e., not just the front or back matter) will not always be available. For this reason, the minimal TOC entry may be used the retrieval unit. These units correspond to the “leaves” of the TOC hierarchy.

Index terms associated with this unit may come from four sources.

1. The TOC entry itself often provides a short passage of words. That is, chapter or section headings or titles, for example, provide an especially useful set of content descriptors.

2. Bibliographic references occurring within the section may refer to citations containing title information that can be associated with the section;

3. index/TOC partitioning (see section 2.2) will provide index terms to be associated with some units.

4. if full-text of interior pages is available, this also provides a source for index terms.

In all cases, lexically-constrained indexing (see section 2.3) is preferably applied.

### 2.2. Index/TOC Partition

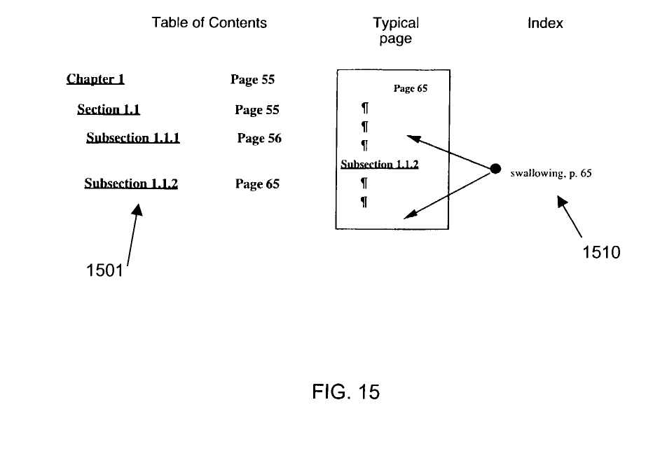

In those cases where a better sources of index terms do not exist, it may be desirable to associate terms found in the books index with TOC entries. This algorithm heuristically forms this association. As shown in FIG. 15, in a first pass the Page range of the entire book is divided into page regions 1501 associated with each TOC entry. With this page partition table (corresponding to each TOC entry) in place, the second pass associates index terms with the TOC entry subsuming this page number. As shown by 1510 in FIG. 15, imprecision of page numbers allows for several categories of errors as well since some pages often span two page regions (corresponding to two TOC entries).

### 2.3. Dome-specific Vocabulary

Knowledge of the jargon/terms-of-art/parlance/sub-language used within a discipline is a large part of what every knowledgeable participant within a discipline must learn before they can truly belong. The present invention includes a number of procedures by which this special vocabulary is derived from ontologies, books, and other centrally-relevant content sources. The present invention provides adaptive mechanisms (see Section 2.8) that allow differential weightings of these terms that capture the special role they play within the “Dome” (or domain of discourse), which will in general be different than that within general or common usage.

### 2.4. Lexically-constrained Indexing

Three unique features of the Dome application shape central features of its unique indexing strategy:

1. saturation of a single domain allows making assumptions about the vocabulary used by content authors and potential users within the dome. In particular, those elements of the Dome-specific vocabulary which should be used for content indexing can be readily identified.

2. the intended users of this technology value recall (vs. precision) enhancing features as would be recognized by those skilled in the art. For .example, see “A cognitive perspective on-search engine technology and WWW” by R. K. Belew, Cambridge Univ. Press, 2000, (hereafter “Belew Reference”) at §4.3.4, the contents of which are incorporated herein in its entirety.

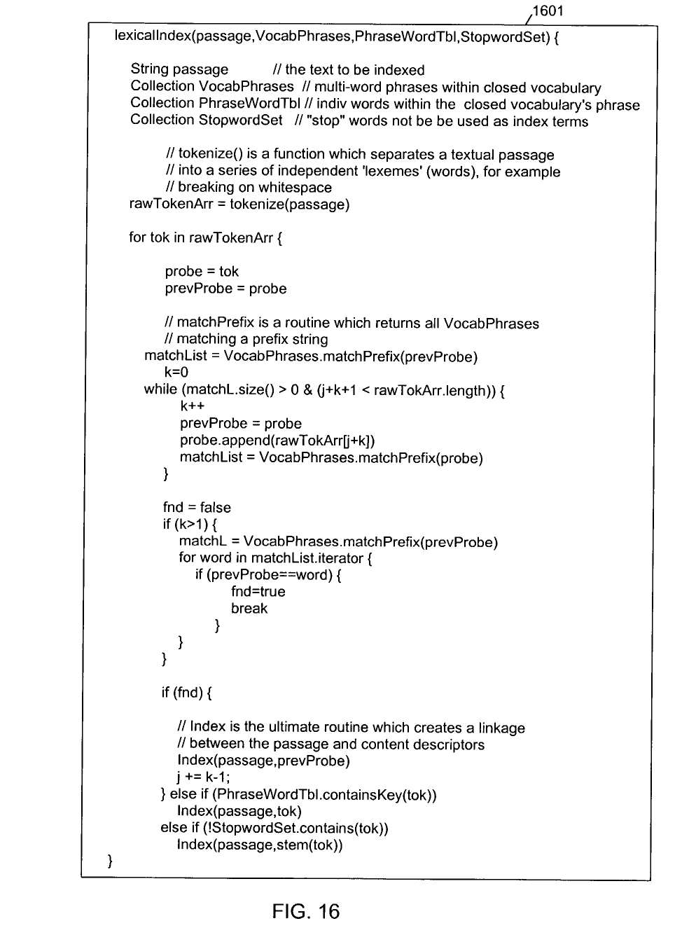

3. High quality resources of central vocabulary are generated by other parts of the dome methodology, in particular, the Ontology, selected dictionaries, and the indices and glossaries of books incorporated into the dome. Lexically-constrained indexing exploits this vocabulary as part of the phrase-based indexing algorithm as shown by the exemplary code fragment 1601 in FIG. 16. Note that this algorithm distinguishes between the a priori “closed” Dome vocabulary and the “open” vocabulary of other potential index terms, allowing variable weighting for the two classes of index terms. See also Belew Reference §1.2.3 which is incorporated herein in its entirety. Since predefined words may be used in the queries, immediate user access to this constrained vocabulary becomes especially important. The phrasal completion widget (see Section 3.2) provides this ability.

### 2.5. Bibliographic Citation Technologies

### 2.5.1. Citation Extraction

Citations are listed at the back of a book (or chapter) in a book-specific typographic style. The extraction of key features within this string (e.g., authors' names, title, journal publication details) requires identification of this style, as well as robust parsing in the face of inconsistent formatting. Identification of manually-curated authority lists of central authors and journals within the Dome increases the fidelity of this operation. That is, by examining the full set of citations across all books, the present invention is able to identify central journals and authors and allows manual curation activity to be spent refining (or “cleaning”) the potential redundancies. This results in authoritative listings (within a specialized knowledge domain) that allows more accurate processing of additional materials as they are incorporated into the Dome.

### 2.5.2. Citation-based Similarity

A second set of descriptive features, beyond the indexing is the set of bibliographic references made within a TOC entry. The relatively constrained size of the set of such citations allows refined similarity measures of co-citation and bibliographic coupling with respect to other books' sections. See Belew Reference §6.1.1 which is incorporated herein in its entirety. That is the set of citations associated with this passage becomes a set of descriptive features, on the basis of which the content of this passage can be compared to other passages. Such analysis complements the more typical lexical analysis of the words in the passages.

### 2.6. Heterogeneous Query Construction

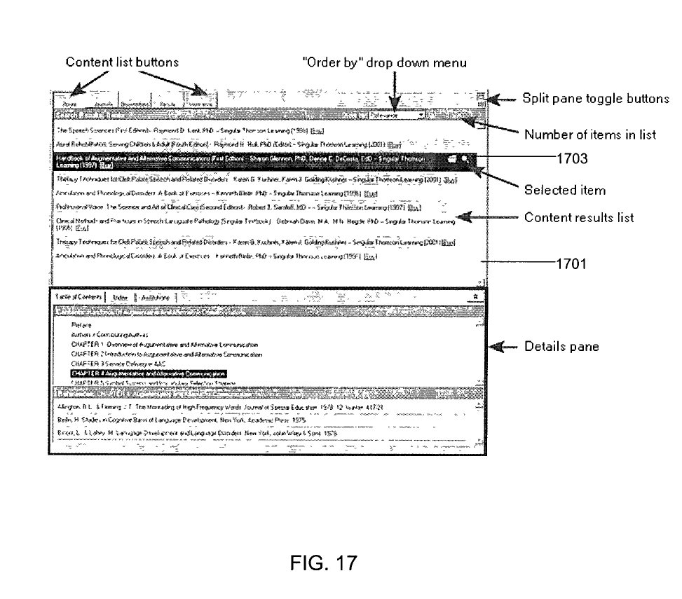

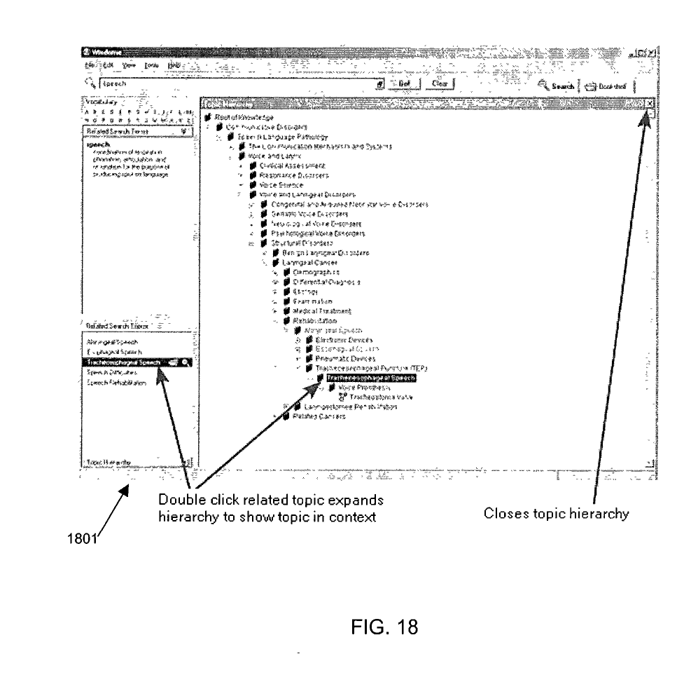

The fact that Domes model a rich mixture of data types, including books authors, institutions, vocabulary terms, ontology categories, creates the need for query expression that allow retrieval across this entire range. This interface element adds the ability to select any element shown on the interface as part of a subsequent search. As shown by the exemplary interface 1701 in FIG. 17, a retrieved books has been selected as a part of a subsequent query as denoted by the “magnifying glass” icon 1703. FIG. 18 shows an exemplary interface 1801 in which an element of an hierarchical ontology has been selected.

### 2.7. Aggregated Match Scoring

Keywords are associated with minimal TOC++ elements. But this evidence(i.e., the fact that particular descriptors are associated with this TOC element) about leaves of the hierarchy can be taken as evidence towards the retrieval of any of the subsuming subsections, section, . . . , chapter elements as well. The present invention computes a length normalization function based on the number of pages and sibling sections at each level, and then take the maximum matching component with respect to this normalization. That is, query terms are guaranteed to occur more frequently in longer passages (e.g., chapters) than in shorter ones (e.g., subsections). The normalization function identifies particularly “focused” occurrences of search terms with respect to the TOC inclusion hierarchy, in order to retrieve the most appropriate levels.

### 2.8. Adaptive Evidence Weighting

Given the mixture of (from TOC, index, full text, citation, etc.) sources of evidence, relative contributions for each must be estimated. The present invention adaptively tunes these suites based on to sources of feedback. First, at an earlier stage of dome development, the test set of queries and relevance assessments for them is generated. Regression of source-specific weights is accomplished with respect to a rank/point alienation error measure. That is, statistical analyses of errors in retrieved rankings, accumulated across the many users and queries observed within the dome, can be attributed back to the weights associated with the various evidence sources that caused the passage to be ranked as it was. See, for example, Belew Reference §§4.3.8 and 5.5.5 which are incorporated herein in their entireties. Later, when substantial real user retrieval behavior has been observed, relevance feedback interpretation and consensual relevance assumptions provide much more data for refined weighting. See Belew Reference §4.3.2 which is incorporated herein in its entirety.

### 3.0 Interface Components

### 3.1. Constructed Query Progress Window

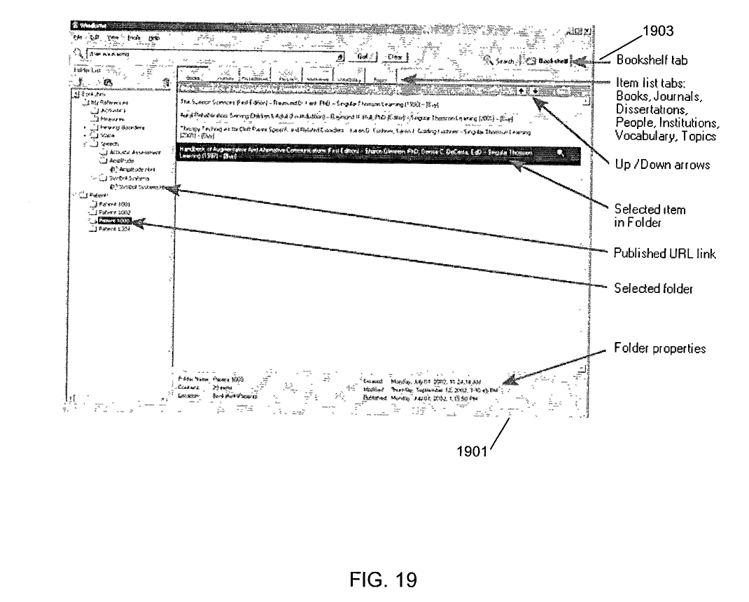

Because the construction of a query is (at least for expert users) a prolonged process, the list of current query elements is always shown as part of the interface. An initial view shows a simple abbreviated list, but expanding this view also shows a vertical, query-element-per-line view, in expanded form. See exemplary view 1901 in FIG. 19 that shows an expanded view of a query window.

### 3.2. Phrasal Completion Widget

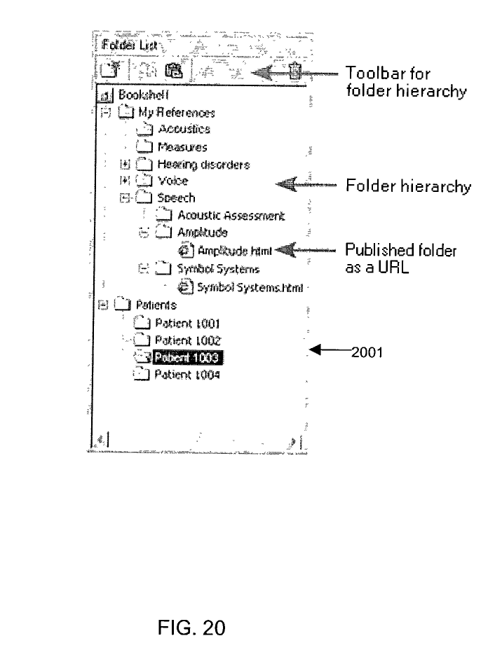

This interface component supports rapid access to the range of dome specific vocabulary. Typing any character immediately shows all vocabulary entries beginning with this letter. “Auto-completion” using a ternary tree allows rapid winnowing of this list as additional characters are typed. The user can click on any element of the list found as the type to select their preference. See FIG. 20 showing an interface 2001 that displays a folder hierarchy based on specific query terms entered by a user. Because users want to be able to rapidly enter several query terms without explicitly the limiting the end of one and the beginning of the other, a simple completion key (tab) communicates this element to the query being constructed.

### 3.3. Preserving State Across Queries

Because the Dome is optimized for high-recall use, users require richer representations of retrieved information. A “Bookshelf” (see tab 1903 is FIG. 19) is provided to the user as a long-term repository, for those retrieved objects as worthy of retention. The bookshelf allows the system to maintain state information across query sessions so that the user is able to organize these found materials as they wish (e.g., for particular patients or projects). These can be merged with materials selected during earlier query sessions. Information on the Bookshelf is always accessible to the user within the Dome, collaborative tools allow groups of Dome users to share their resources, and specially-rendered “public” versions can be made available to others who are not Dome users.

One skilled in the art would recognize that various computing environments, communication environments, hardware/software, computer data signals, and program code could be used to implement the present invention based on the disclosure provided herein and all of these are explicitly considered a part of the present invention.

Other embodiments of the invention will be apparent to those skilled in the art from a consideration of the specification and the practice of the invention disclosed herein. It is intended that the specification be considered as exemplary only, with the true scope and spirit of the invention also being indicated by the following claims.

What is claimed is:

1. A computer implemented method of retrieving information based on front and back matter data related to the information, comprising:
receiving search terms for retrieval of information;
comparing search terms to the front and back matter data of information for incidence and/or spatial relationships;
developing a weighted score for the information based on the comparison and/or spatial relationships; and
retrieving information based on the weighted score.

2. The computer implemented method according to claim 1, wherein the information comprises books, journals, or other publications related to a specialized field of knowledge.

3. The computer implemented method according to claim 2, wherein the specialized field of knowledge comprises scientific, technical, or medical fields.

4. The computer implemented method according to claim 1, wherein the front and back matter data of information comprises data that is a part of one of structural components of the information comprising a title, library of congress data, a table of contents, an index, a glossary, or a references section of the information.

5. The computer implemented method according to claim 2, wherein the information comprises books, journals, dissertations, or other publications.

6. The computer implemented method according to claim 4, wherein the incidence of the search terms in the different structural components are given different weights.

7. The computer implemented method according to claim 1, further comprising:
ranking the retrieved information based on respective weighted scores of the retrieved information; and
transmitting the ranked retrieved information for display arranged on the basis of the weighted scores of the retrieved information.

8. The computer implemented method according to claim 1, wherein the front and back matter data of information comprises data that is a part of one of structural components of the information comprising a containment hierarchy, a subject index, bibliographic citations, glossary, or interior pages of the information.

9. The computer implemented method according to claim 2, further comprising developing a specialized vocabulary related to the specialized field of knowledge.

10. The computer implemented method according to claim 9, further comprising providing a phrasal completion widget that offers suggestions from the specialized vocabulary based on parts of search terms entered by a user.

11. The computer implemented method according to claim 10, wherein the phrasal completion widget provides for:
displaying all specialized vocabulary entries when receiving a first character entered for a search term; and
auto-completing the search term as additional characters of the search term are entered by matching with the specialized vocabulary entries.

12. The computer implemented method according to claim 9, wherein search terms that are a part of the specialized vocabulary are given a differential weight when developing the weighted score for the information.

13. The computer implemented method according to claim 8, wherein the step of developing the weighted scores comprises:
determining location of the search terms within the containment hierarchy of the information;
determining a length normalization function based on the number of pages and the sibling sections at the location of the search terms within the containment hierarchy; and
calculating the weighted score of the search terms based on the length normalization function.

14. The computer implemented method according to claim 6, further comprising:
running search terms to retrieve information based on weighted scores using a first set of weights for the different structural components;
determining the relevance of the retrieved information and its correlation to the first set of weights; and
adjusting the first set of weights based on the determined relevance of the retrieved information and its comparison with the first set of weights.

15. The computer implemented method according to claim 1, further comprising;
retaining some of the retrieved information as state information preserved across query sessions based on an indication by a user of the retrieved information.

16. The computer implemented method according to claim 1, further comprising:
receiving additional search terms from a user after retrieving and displaying information based on search terms provided by the user; and
recalculating the weighted score based on the additional search terms; and
retrieving information based on the recalculated weighted score.

17. A computer readable medium having program code stored thereon that causes a computing system to retrieve information based on front and back matter data related to the information by performing the following steps comprising:
receiving search terms for retrieval of information;
comparing search terms to the front and back matter data of information for incidence and/or spatial relationships;
developing a weighted score for the information based on the comparison and/or spatial relationships; and
retrieving information based on the weighted score.

18. The computer readable medium according to claim 17, wherein the information comprises books, journals, or other publications related to a specialized field of knowledge.

19. The computer readable medium according to claim 17, wherein the front and back matter data of information comprises data that is a part of one of structural components of the information comprising a containment hierarchy, a subject index, bibliographic citations, glossary, or interior pages of the information.

20. The computer readable medium according to claim 18 wherein the program code further causes the computing system to perform the following steps comprising:
developing a specialized vocabulary related to the specialized field of knowledge.

21. The computer readable medium according to claim 19, wherein the program code further causes the computing system to perform the following steps comprising:
determining a location of the search terms within the containment hierarchy of the information;
determining a length normalization function based on the number of pages and sibling sections at the location of the search terms within the containment hierarchy; and
calculating the weighted score of the search terms based on the length normalization function.

22. The computer readable medium according to claim 19, wherein the program code further causes the computing system to perform the following steps comprising:
running search terms to retrieve information based on weighted scores using a first set of weights for the different structural components;
determining the relevance of the retrieved information and its correlation to the first set of weights; and
adjusting the first set of weights based on the determined relevance of the retrieved information and its comparison with the first set of weights.

23. The computer readable medium according to claim 19, wherein the program code further causes the computing system to perform the following steps comprising:
retaining some of the retrieved information as state information preserved across query sessions based on an indication by a user of the retrieved information.

24. A computer implemented method of retrieving information based front and back matter data related to the information, comprising:
providing search terms for the retrieval of information; and
receiving retrieved information based on the search terms,
wherein the search terms are compared to the front and back matter data of information for incidence and/or spatial relationships, a weighted score is developed for the information based on the incidence and/or spatial relationships, and retrieved information is retrieved based on the weighted score.

25. A system for retrieving information based on the front and back matter data related to the information comprising:
means for receiving search terms for retrieval of information;
means for comparing search terms to the front and back matter data of information for incidence and/or spatial relationships;
means for developing a weighted score for the information based on the comparison and/or spatial relationships; and
means for retrieving information based on the weighted score,
wherein the information comprises books, journals, or other publications related to a specialized field of knowledge.

26. A system for retrieving information based on the front and back matter data related to the information comprising:
a server unit configured for receiving search terms for retrieval of information, comparing search terms to the front and back matter data of information for incidence and/or spatial relationships, developing a weighted score for the information based on the comparison and/or spatial relationships, and retrieving information based on the weighted score,
wherein the information comprises books, journals, or other publications related to a specialized field of knowledge.

27. The system according to claim 26, further comprising:
a client unit connected to the server unit through a communication network, wherein the client unit comprises an interface for generating search terms in communication with the server unit, and receiving and displaying the information retrieved by the server unit.

28. The system according to claim 27, wherein the communications network is the Internet and the client unit interface is a web browser.
